(19) United States
(12) Patent Application Publication
(10) Pub. No.: US 2019/0013557 A1
(43) Pub. Date: Jan. 10, 2019

(54) CROSSTALK ISOLATION STRUCTURE

(71) Applicant: Chia-Ho Wu, Tainan (TW)

(72) Inventor: Chia-Ho Wu, Tainan (TW)

(21) Appl. No.: 16/112,919

(22) Filed: Aug. 27, 2018

Related U.S. Application Data
(63) Continuation-in-part of application No. 14/991,212, filed on Jan. 8, 2016, now Pat. No. 10,090,574.

(30) Foreign Application Priority Data
Aug. 24, 2015 (TW) 104127438

(51) Int. Cl. H01P 3/08; H01P 1/20

(52) U.S. Cl. CPC H01P 1/20; H01P 3/081

(57) ABSTRACT

The present invention provides a crosstalk isolation structure for reducing crosstalk, comprising a conductive line and two grounded resistors. The conductive line comprises a plurality of teeth structures arranged periodically. The two grounded resistors are coupled to two ends of the conductive line, respectively. The plurality of teeth structures are periodically arranged in a subwavelength configuration that a period length of the plurality of teeth structures is smaller than the wavelength of an electromagnetic signal generated by a crosstalk around the conductive line, whereby impingement of electromagnetic wave is isolated by the plurality of teeth structures.

### BACKGROUND OF INVENTION

### 1. Field of the Invention

The present invention relates to an isolation structure and, more particularly, to an isolation structure for isolating crosstalk interference between the transmission lines.

### 2. Description of the Prior Art

In recently years, with the package size of electronic products becoming smaller and signal transmission rate becoming higher in the high-frequency circuit or high-speed digital system, electronic circuits tend to be designed to more intensive or to operate at high microwave frequency. Accordingly, the crosstalk phenomenon between electronic circuits becomes more serious than ever before. When signals are transmitted via transmission channel, adjacent transmission lines will be interfered by each other due to electromagnetic coupling phenomenon; therefore, the interfered transmission lines may generate coupling voltage and current, which is so-called crosstalk. Excessive crosstalk may influence the efficiency of the system, or result in the mis-trigger of the circuit thereby damaging the system. Besides, when designing a bent electronic circuit, engineers usually increase the interval between the adjacent transmission lines, or increase the rising time or the falling time of the digital signals in order to reduce the crosstalk; however, the crosstalk still cannot be completely eliminated.

Conventionally, the periodic structure formed in circuits is usually for band stop; however, it has no practical because of its long length. In addition, another purpose of the periodic structure in conventional circuits is to serve as a proper R-L structure for coupling adjacent circuits. Therefore, the periodic structure is nothing about the reducing of crosstalk in prior art.

Currently, there are two common methods to depress crosstalk effect. One is to add the number of bending in a differential pair or single-ended line to reduce crosstalk effect; however, it may increase the common mode signal rapid in the differential pair, which is unfavorable to the operation of the whole circuit. The other is to install additional ground lines through the via holes between adjacent circuits; however, it could result in two obvious shortcomings including, firstly, the areas of the circuits cannot be small, and secondly, the ground lines can only block electrical field, but it cannot effectively depress the mutual inductance between lines. In addition, the aforesaid two conventional methods will almost lose effectiveness when the frequency or speed rate is getting higher. Because of the notable capacitance effect existed between the ground line and the transmission line, the raising time of the digital signal will be delay and then the transmission speed of digital signal will be de dropped. Therefore, we must develop new technology to solve these problems.

Park disclosed a guard trace pattern in US patent application publication number US2008/0053694 as shown in FIG. 19. Park disclosed that an interval of 100 mil between the guard trace patterns is the most effective value according to experiments.

Wu disclosed a differential microstrip lines having slots therein of subwavelength configuration in U.S. Pat. No. 9,615,446.

But if we simply combine Park's guard trace pattern and Wu's subwavelength, we will get worse result. Please refer to FIG. 20, which shown part of enlarged view of guard trace pattern of Park. Park disclosed that d₁ is 100 mil, W₁=W₂=W₃=6 mil, b=12 mil, and w=14 mil. If we choice d₂=25 mil, and the total length of the guard trace pattern is 4000 mil, we can get a simulation result as shown in FIGS. 21a and 21b. Compare the simulation result of Park with that of the other example which choice d₁=40 mil to reflect the structure of Park combining Wu's subwavelength, we can see that the crosstalk S₄₁ of the example that combining Park and Wu is getting higher and worse. Crosstalk S₄₁ of Park combining Wu is higher than that of Park's original guard trace pattern therefore teaches away from combining Park's pattern and Wu's subwavelength structure.

Because the conventional methods cannot effectively eliminate the crosstalk occurring around the transmission line, it is necessary to propose novel structure for isolating transmission lines from each other, suppressing the crosstalk and reducing the mode conversion effect from differential mode to common mode.

### SUMMARY OF THE INVENTION

The present invention provides an isolation structure for isolating transmission lines.

Other objects and advantages of the invention could be further illustrated by the technical features broadly embodied and described as follows.

In order to achieve one or a part of or all of the above advantages or other advantages, an embodiment of the present invention provides an isolation structure includes a conductive line, and two grounded resistors. The conductive line includes a plurality of teeth structures arranged periodically. These two grounded resistors connected to two ends of the conductive line, respectively. Wherein the plurality of teeth structures are periodically arranged that a period length of the plurality of teeth structures is smaller than a wavelength of an electromagnetic signal generated by a crosstalk around the conductive line.

An embodiment of the invention provides a crosstalk isolation structure, wherein the depth b of the teeth structures and the distance W1 between a source of electromagnetic wave and the teeth structures satisfies the relation that W1/(W1+b)>⅓.

An embodiment of the invention provides a crosstalk isolation structure, wherein the depth b of the teeth structures and the distance W1 between a source of electromagnetic wave and the teeth structures satisfies the relation that b/(W1+b)<⅔.

An embodiment of the invention provides a crosstalk isolation structure, wherein the depth b of the teeth structures and the distance W1 between a source of electromagnetic wave and the teeth structures satisfies the relation that W1/(W1+b)≥ 4/9.

An embodiment of the invention provides a crosstalk isolation structure, wherein the depth b of the teeth structures and the distance W1 between a source of electromagnetic wave and the teeth structures satisfies the relation that b/(W1+b)≤ 5/9.

An embodiment of the invention provides a crosstalk isolation structure, wherein the depth b of the teeth structures and the distance W1 between a source of electromagnetic wave and the teeth structures satisfies the relation that W1/(W1+b)≥ 5/9.

An embodiment of the invention provides a crosstalk isolation structure, wherein the depth b of the teeth structures and the distance W1 between a source of electromagnetic wave and the teeth structures satisfies the relation that b/(W1+b)≤ 4/9.

An embodiment of the invention provides a crosstalk isolation structure further comprises a substrate layer composed of at least an oxide wherein the conductive line is disposed on the substrate layer.

An embodiment of the invention provides a crosstalk isolation structure further comprises oxide material or dielectric material between a source of electromagnetic wave and the teeth structures.

An embodiment of the invention provides a crosstalk isolation structure, wherein the grounded resistors composed of semiconductor material such as metal silicide or poly silicon or amorphous silicon or others.

An embodiment of the invention provides a crosstalk isolation structure, wherein the conductive line is made by the technology of semiconductor interconnect.

Based on the above, the crosstalk isolation structure comprises a conductive line having a plurality of teeth structures periodic arranged with a period length smaller than one or one fourth of the wavelength of electromagnetic signal generated by a crosstalk around the conductive line and two grounded resistors. The impingement of electromagnetic wave is almost isolated by the crosstalk isolation structure.

Since the period length is much smaller than wavelength, its working frequency is far away from the band gap and the coupling with the conventional transmission line is extremely low. The present invention is applicable to high-frequency microwave circuit and high-speed circuit; in particular, the present invention can effectively block the mutual interference in an intensive circuit. In addition, the crosstalk isolation structure of the present invention can also be utilized to isolate differential pairs for preventing coupling between these differential pairs.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 disclose a first embodiment of the crosstalk isolation structure;

FIG. 2 disclose a second embodiment of the crosstalk isolation structure;

FIG. 3 disclose part of top and cross section views of the structure in FIG. 2;

FIG. 4 disclose a third embodiment of the crosstalk isolation structure;

FIG. 5 disclose part of top and cross section view of the structures in FIG. 4;

FIG. 6 disclose a fourth embodiment of the crosstalk isolation structure;

FIG. 7 disclose a fifth embodiment of the crosstalk isolation structure;

FIG. 8 disclose a sixth embodiment of the crosstalk isolation structure;

FIG. 9 disclose a top view and a cross section views of crosstalk isolation structure arranged between two microstrip transmission lines according to a seventh embodiment of the present invention;

FIG. 10 disclose a top and cross section views of the crosstalk isolation structure arranged between two differential pairs of microstrip transmission lines according to an eighth embodiment of the present invention;

FIG. 11 disclose a ninth embodiment of the crosstalk isolation structure;

FIG. 12 disclose a tenth embodiment of the crosstalk isolation structure;

FIG. 13 disclose an eleventh embodiment of the crosstalk isolation structure;

FIG. 14 disclose a twelfth embodiment of the crosstalk isolation structure;

FIG. 15 disclose a thirteenth embodiment of the crosstalk isolation structure;

FIG. 16 disclose a simulation result of seventh embodiment shown in FIG. 9;

FIG. 17 disclose a top and a cross section views of a fourteenth embodiment of the crosstalk isolation structure arranged between a differential pair of microstrip transmission lines and a single microstrip transmission line; and

FIG. 18 discloses a simulation result of S parameter of the crosstalk isolation structure shown in FIG. 17.

FIG. 19 disclose a prior art structure of Park;

FIG. 20 disclose part of enlarge view of a prior art structure of Park;

FIG. 21a disclose the relationship between S parameters and frequency of the simulation result between the structure of Park and the structure of Park combining Wu;

FIG. 21b disclose the simulation result of suppression effect of between the structure of Park and the structure of Park combining Wu on time domain signal crosstalk;

FIG. 22a disclose the relationship between S parameters and frequency of the simulation result between the structure of Park and the structure of sixteenth embodiment of the present invention;

FIG. 22b disclose the simulation result of suppression effect of between the structure of Park and the structure of sixteenth embodiment of the present invention on time domain signal crosstalk;

FIG. 23a disclose the relationship between S parameters and frequency of the simulation result between the structure of Park and the structure of seventeenth embodiment of the present invention;

FIG. 23b disclose the simulation result of suppression effect of between the structure of Park and the structure of seventeenth embodiment of the present invention on time domain signal crosstalk;

FIG. 24 disclose another embodiment of the crosstalk isolation structure of the present invention;

FIG. 25 disclose another embodiment of the crosstalk isolation structure of the present invention;

FIG. 26 disclose another embodiment of the crosstalk isolation structure of the present invention;

FIG. 27 disclose another embodiment of the crosstalk isolation structure of the present invention;

FIG. 28 disclose another embodiment of the crosstalk isolation structure of the present invention;

FIG. 29 disclose another embodiment of the crosstalk isolation structure of the present invention;

FIG. 30 disclose another embodiment of the crosstalk isolation structure of the present invention;

FIG. 31 disclose another embodiment of the crosstalk isolation structure of the present invention;

FIG. 32 disclose another embodiment of the crosstalk isolation structure of the present invention;

FIG. 33 disclose another embodiment of the crosstalk isolation structure of the present invention;

FIG. 34 disclose another embodiment of the crosstalk isolation structure of the present invention;

FIG. 35 disclose another embodiment of the crosstalk isolation structure of the present invention.

### DESCRIPTION OF THE PREFERRED EMBODIMENT

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations there of herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and in direct facing, and “adjacent to” and variations thereof herein are used broadly and encompass directly and indirectly “adjacent to”. Therefore, the description of “A” component facing “B” component herein may contain the situations that “A” component directly facing “B” component or one or more additional components are between “A” component and “B” component. Also, the description of “A” component “adjacent to “B” component herein may contain the situations that “A” component is directly “adjacent to “B” component or one or more additional components are between “A” component and “B” component. Accordingly, the drawings and descriptions will be regarded as illustrative in nature and not as restrictive.

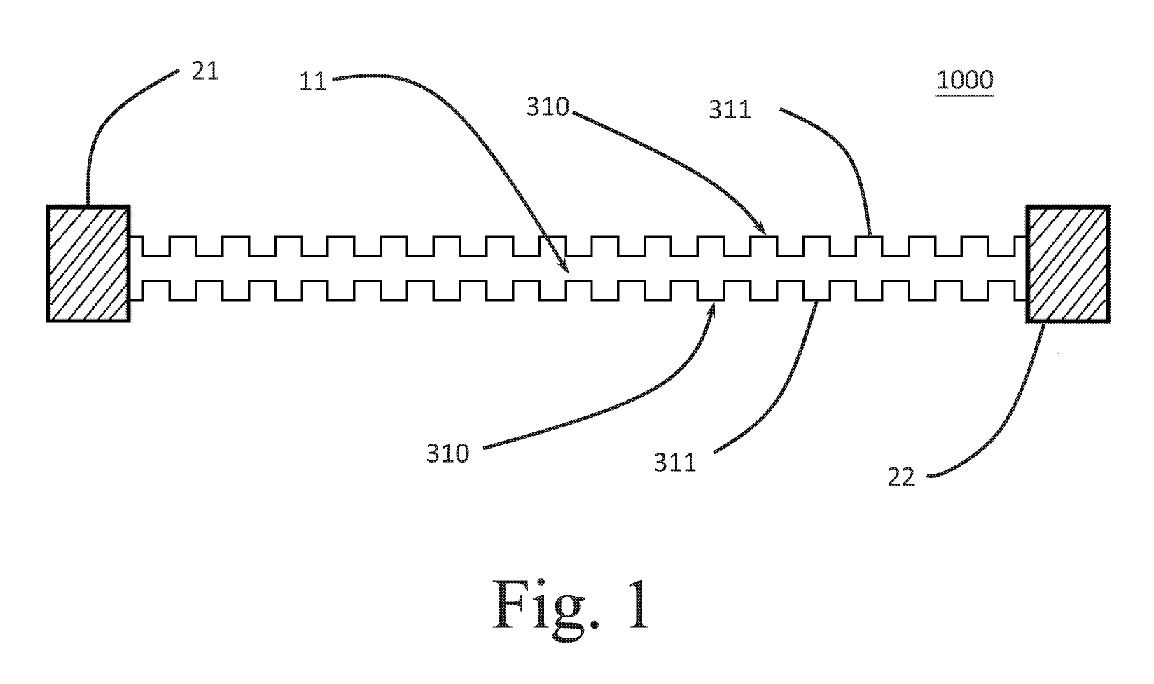

The present invention provides a crosstalk isolation structure 1000 for reducing a crosstalk effect. In a first embodiment shown in FIG. 1, the crosstalk isolation structure 1000 comprises a conductive line 11 and two resistors 21, 22. The conductive line 11 has a plurality of teeth structures 310 with periodic arrangement. One resistor 21 is connected to one end of the conductive line 11 and the other resistor 22 is connected to the other end of the conductive line 11, wherein the two resistors 21, 22 are grounded and are impedance matched with the conductive line 11.

The plurality of teeth structures 310 are periodically formed at two lateral sides of the conductive line 11 in a subwavelength configuration. In the present embodiment, the plurality of teeth structures 310 are configured by a plurality of rectangle projections 311 periodically and alternately spaced. The period length of these teeth structures 310 is less than the wavelength of an electromagnetic signal generated by a crosstalk around the conductive line 11.

The isolation structure is formed by etching the lateral sides of a conductive line 11 to form periodic structure having subwavelength configuration, such as a plurality of teeth structures 310, for example, and connecting resistors 21, 22 to the conductive line wherein the impedance of the resistors 21, 22 are matched with the impedance of the conductive line 11.

The conductive line is composed of metal, metal silicide, semiconductor material or other conductive material. The semiconductor material may include homo-structure or hetero-structures. The material of teeth structures is the same with the conductive line. The resistor is composed of metal silicide, poly-silicon, amorphous silicon, semiconductor material, or carbon film.

Subwavelength configuration is that the period of the periodic structure is less than the wave length of electromagnetic signal. The period of the periodic structure may less than one or one fourth of the wave length of electromagnetic signal. Since the coupling amount between the conductive line having periodic subwavelength configuration and other transmission line is quite few and the resistors connected to the conductive line having periodic subwavelength configuration can effectively conduct the electrical signals into ground, the isolation structure of the present invention can effectively separate two microstrip transmission lines or strip-typed transmission lines from each other. The conductive line having periodic subwavelength configuration can simply be made by the technology of interconnect in integrated circuit, transmission line, antenna, microstrip line having a single grounded plane, or strip-typed structure that are grounded at top and bottom sides.

Since the coupling effect between the periodic subwavelength structure of the present invention and conventional transmission lines is extremely small, it can be utilized as an isolation structure to reduce mutual inductance between two signal transmission lines. The isolation will become stronger if the frequency of the signal is higher. It should be noted that the crosstalk isolation structure of the present invention is not used for signal transmission. The conductive line of the crosstalk isolation structure is not a transmission line for signal transmission.

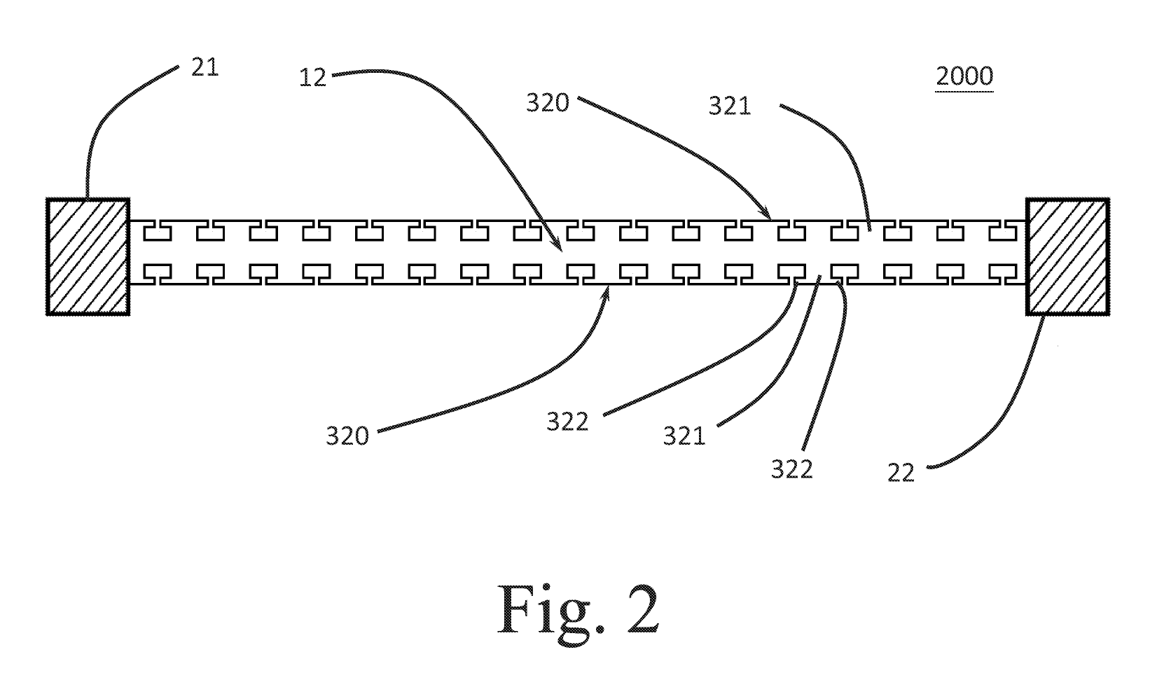

The second embodiment of crosstalk isolation structure 2000 for reducing crosstalk is shown in FIG. 2, in which the teeth structures 320 formed at two lateral sides of the crosstalk isolation structure 2000 has bi-directional extension parts. In the present embodiment, the crosstalk isolation structure 2000 comprises a conductive line 12 and two resistors 21, 22. The conductive line 12 has a plurality of teeth structures 320 with periodic arrangement. One end of the conductive line 12 is connected to one resistor 21 while the other end of the conductive line 12 is connected to the other resistor 22. Another ends of two resistors 21, 22 are grounded and are impedance matched with the conductive line 12. The plurality of teeth structures 320 are formed at two corresponding lateral sides of the conductive line 12 in a subwavelength configuration.

The teeth structures 320 are configured by a plurality of rectangle projections 321 periodically and alternately spaced so as to form the periodic teeth structures 320. Each rectangle projection 321 has two extension parts 322 oppositely and extending in parallel direction. In the present embodiment, the subwavelength configuration of the conductive line 12, is that the period length of these teeth structures 320 is equal or less than the subwavelength, on the other words, less than one or one fourth of the wavelength of an electromagnetic signal generated by a crosstalk around the conductive line 12.

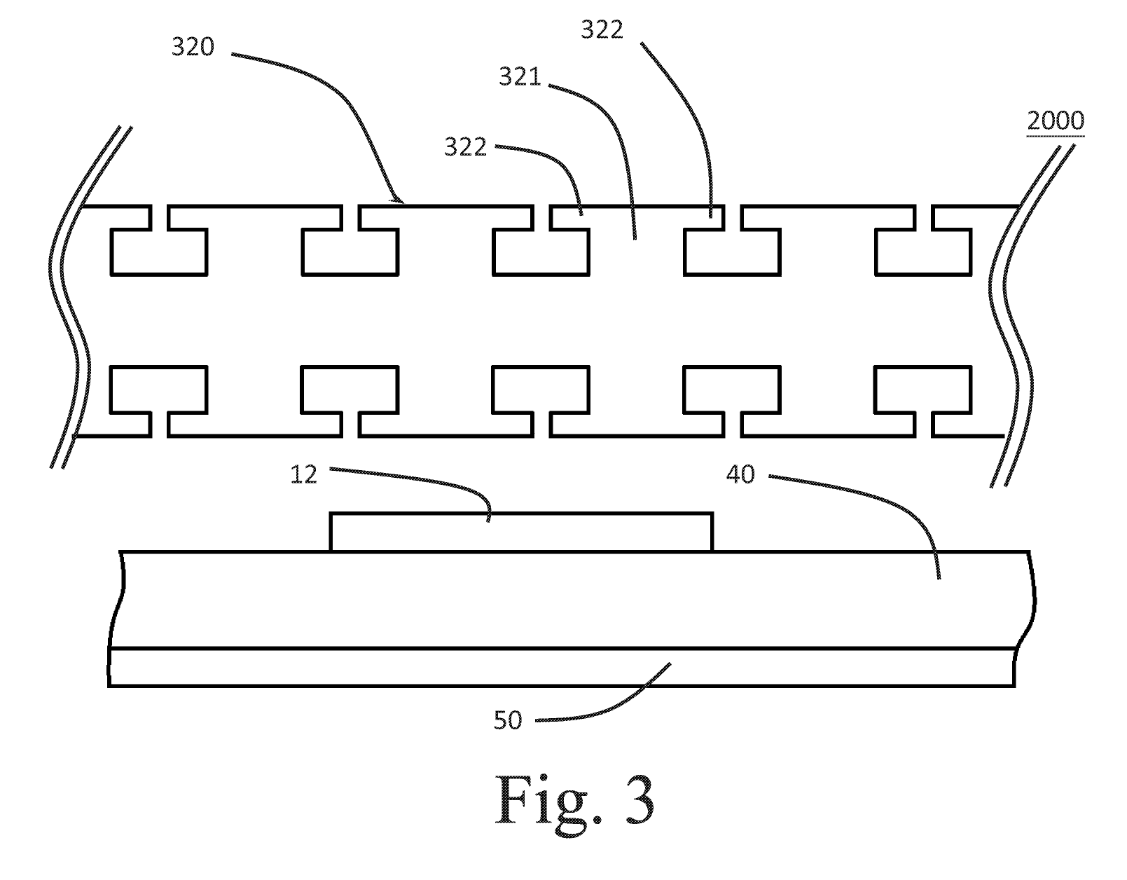

Please refer to FIG. 3, which illustrates a detail enlarged view of partial teeth structures 320 of the conductive line 12 shown in FIG. 2, wherein the upper part of the FIG. 3 is a top view of the enlarged part of teeth structures 320 and the bottom part is a cross-sectional view of the enlarged part of the teeth structures 320. The conductive line 12 is disposed on a substrate layer 40, and a grounded layer 50 is under the substrate layer 40. The substrate 40 is composed of dielectric or oxide or insulating materials. The grounded layer is composed of metal or other conductive materials.

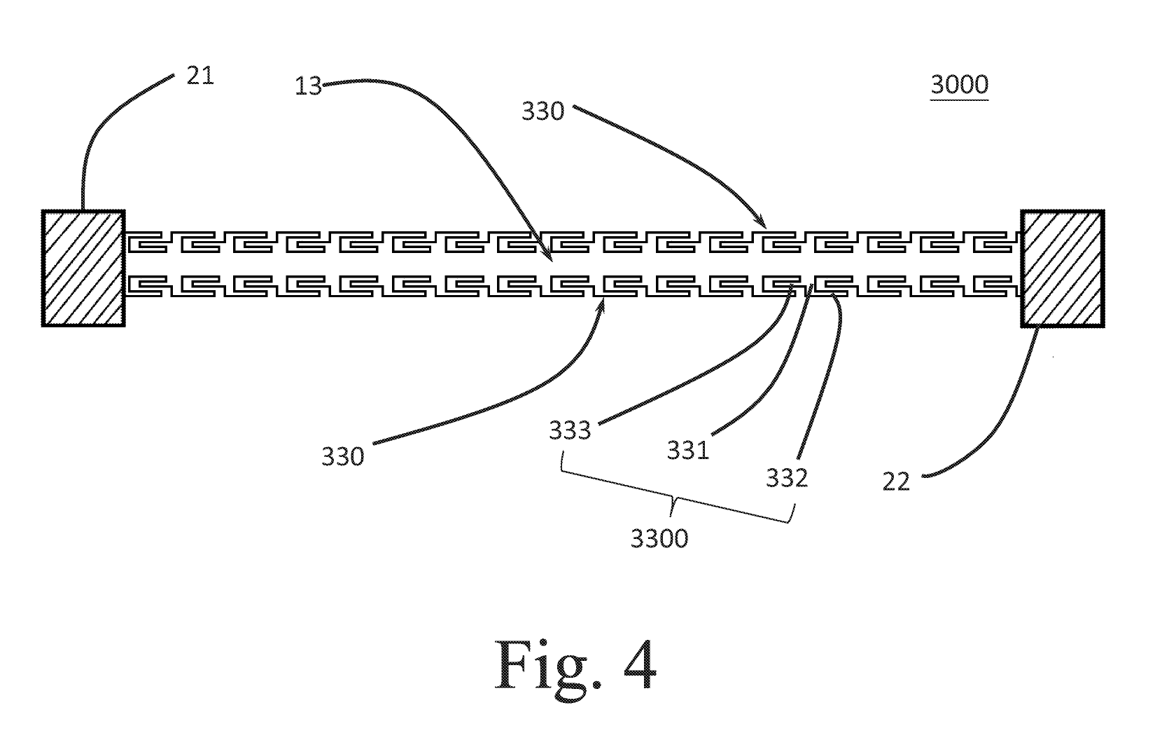

The third embodiment of the crosstalk isolation structure 3000 having comb structure is illustrated as FIG. 4, wherein the crosstalk isolation structure 3000 comprises a conductive line 13 and two resistors 21, 22. The conductive line 13 comprises a plurality of teeth structures 330 wherein one end of the conductive line 13 is connected to one resistor 21 while the other end of the conductive line 13 is connected to the other resistor 22. The two resistors 21, 22 are grounded and are impedance matched with the conductive line 13. The plurality of teeth structures 330 are periodically formed at two corresponding lateral sides of the conductive line 13 in a subwavelength configuration.

Each teeth structure 330 has a Z-shaped projection 3300, wherein each Z-shaped projection 3300 further comprises a first extension part 332 connected to the tip of the projection body 331, and a second extension part 333 connected to a middle section of the projection body 331, wherein the first extension part 332 and the second extension part 333 are extended in opposite direction.

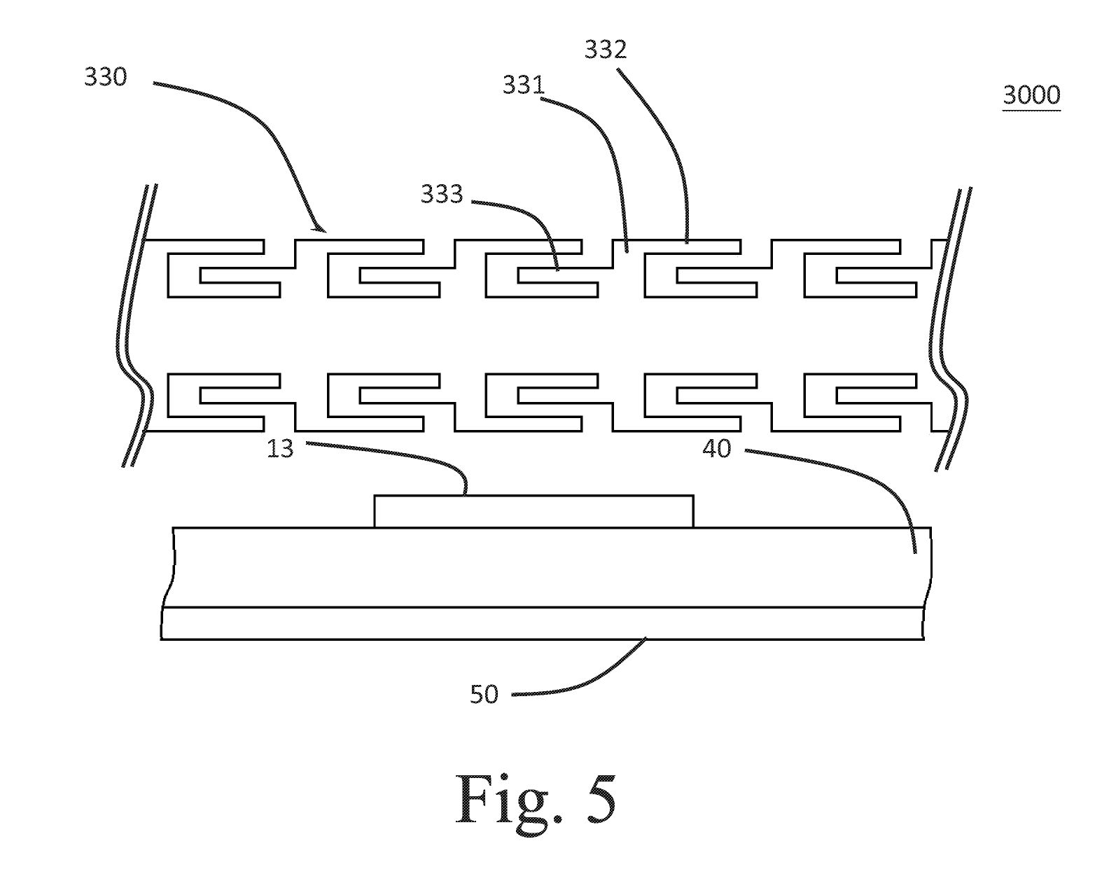

Please refer to FIG. 5, which illustrates a detail enlarged view of a part of teeth structures 330 shown in FIG. 4. The upper part of the FIG. 5 is a top view of the enlarged part of teeth structures 330. In addition, the bottom part of FIG. 5 illustrates a cross-sectional view of the crosstalk isolation structure 3000, from the bottom layer to the top layer, includes a grounded layer 50, and a substrate 40. The substrate 40 is composed of dielectric or oxide or insulating materials. The grounded layer is composed of metal or other conductive materials.

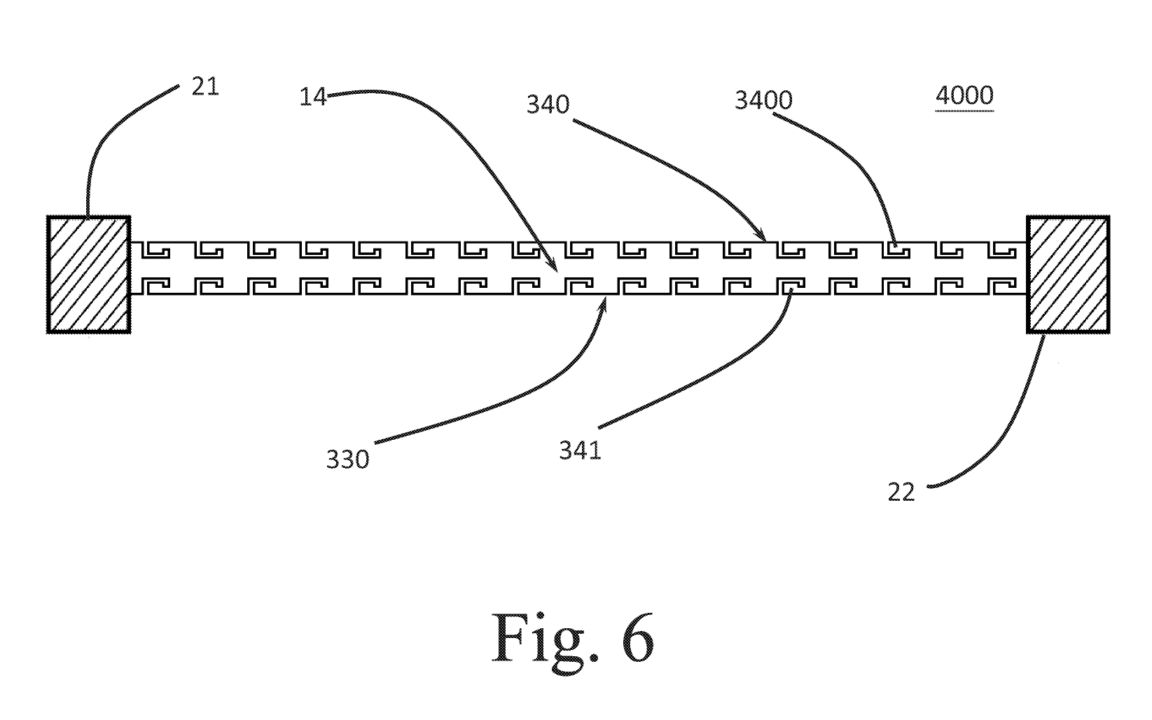

Please refer to FIG. 6, which illustrates a fourth embodiment where each teeth structure 340 has a J-shaped projection 3400. In the present embodiment, the crosstalk isolation structure 4000 comprises a conductive line 14 and two resistors 21, 22. The conductive line 14 comprises a plurality of teeth structures 340 arranged periodically. One resistor 21 is coupled to the one end of the conductive line 14 while the other resistor 22 is coupled to the other end of the conductive line 14. The two resistors 21, 22 are grounded and are impedance matched with the conductive line 14. The plurality of teeth structures 340 are formed at the two lateral sides of the conductive line 14 in a subwavelength configuration. Each teeth 340 comprises a J-shaped projection 3400 having a hook part 341 bending toward the conductive line 14.

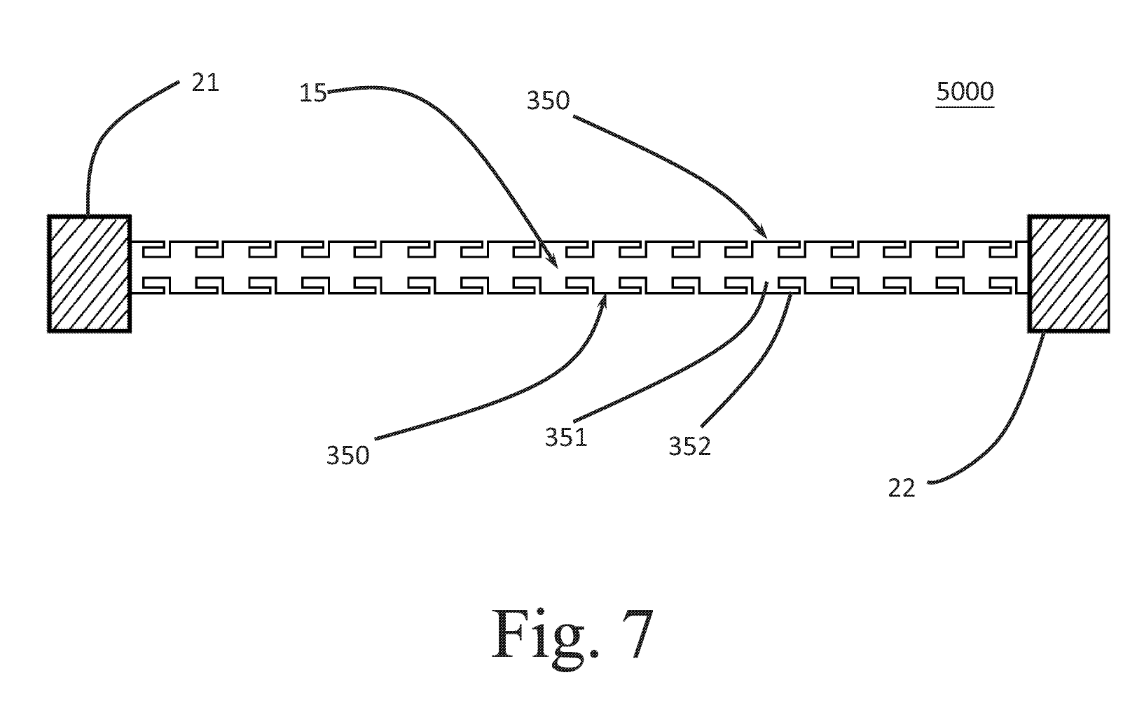

Please refer to FIG. 7, which illustrates a fifth embodiment where each teeth structure 350 has a extension part 352 along one direction. In the present embodiment, the crosstalk isolation structure 5000 comprises a conductive line 15 and two resistors 21, 22. The conductive line 15 comprises a plurality of teeth structures 350 having a periodic arrangement. One resistor 21 is coupled to the one end of the conductive line 15 while the other resistor 22 is coupled to the other end of the conductive line 15. The two resistors 21, 22 are grounded and are impedance matched with the conductive line 15. The plurality of teeth structures 350 are formed at the two lateral sides of the conductive line 15 in a subwavelength configuration.

Each teeth 350 comprises a rectangle projection 351 connected thereto such that the plurality of teeth structures 350 are configured by a plurality of rectangle projections 351 periodically and alternately spaced. Each rectangle projection 351 further has an extension part 352 extending in a direction parallel the longitudinal direction of the conductive line 15.

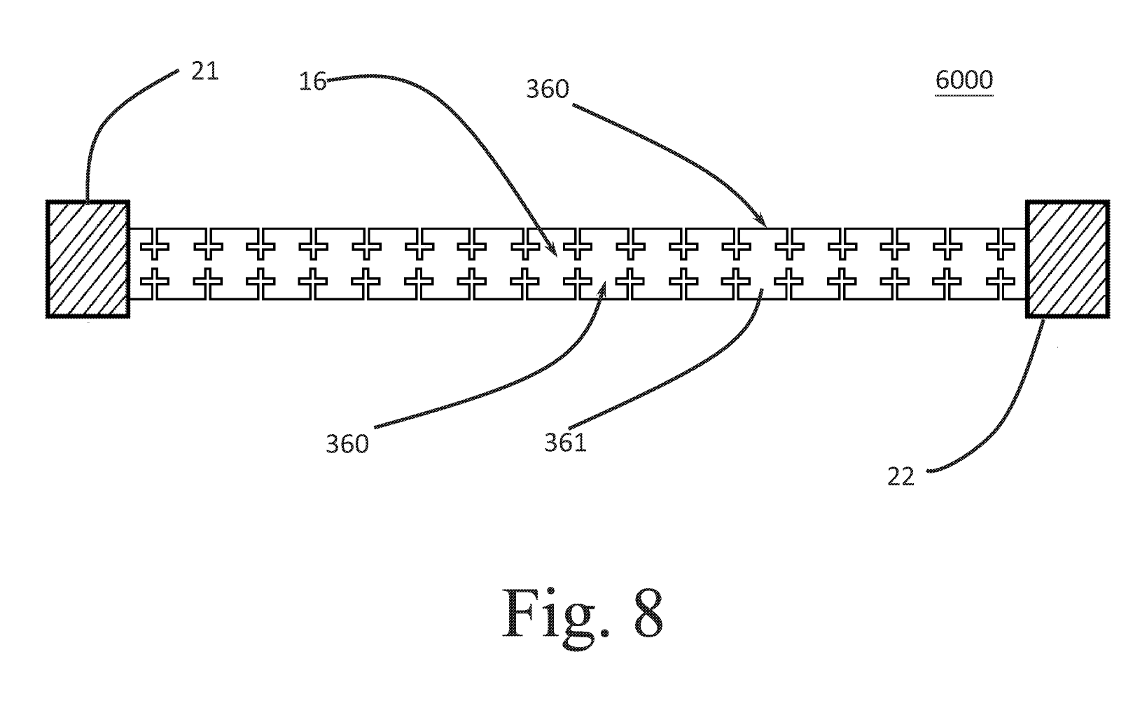

Please refer to FIG. 8, which illustrates a sixth embodiment where each teeth structure 360 has a cross-shaped recess. In the present embodiment, the crosstalk isolation structure 6000 comprises a conductive line 16 and two resistors 21, 22. The conductive line 16 comprises a plurality of teeth structures 360 arranged periodically. One resistor 21 is coupled to the one end of the conductive line 16 while the other resistor 22 is coupled to the other end of the conductive line 16. The two resistors 21, 22 are grounded and are impedance matched with the conductive line 16. The plurality of teeth structures 360 are formed at the two lateral sides of the conductive line 16 in a subwavelength configuration.

The plurality of teeth structures 360 are configured by a plurality of projections 361 periodically and alternately spaced, wherein each projection 361 is formed a cross-shaped recess together with its nearby projection 361.

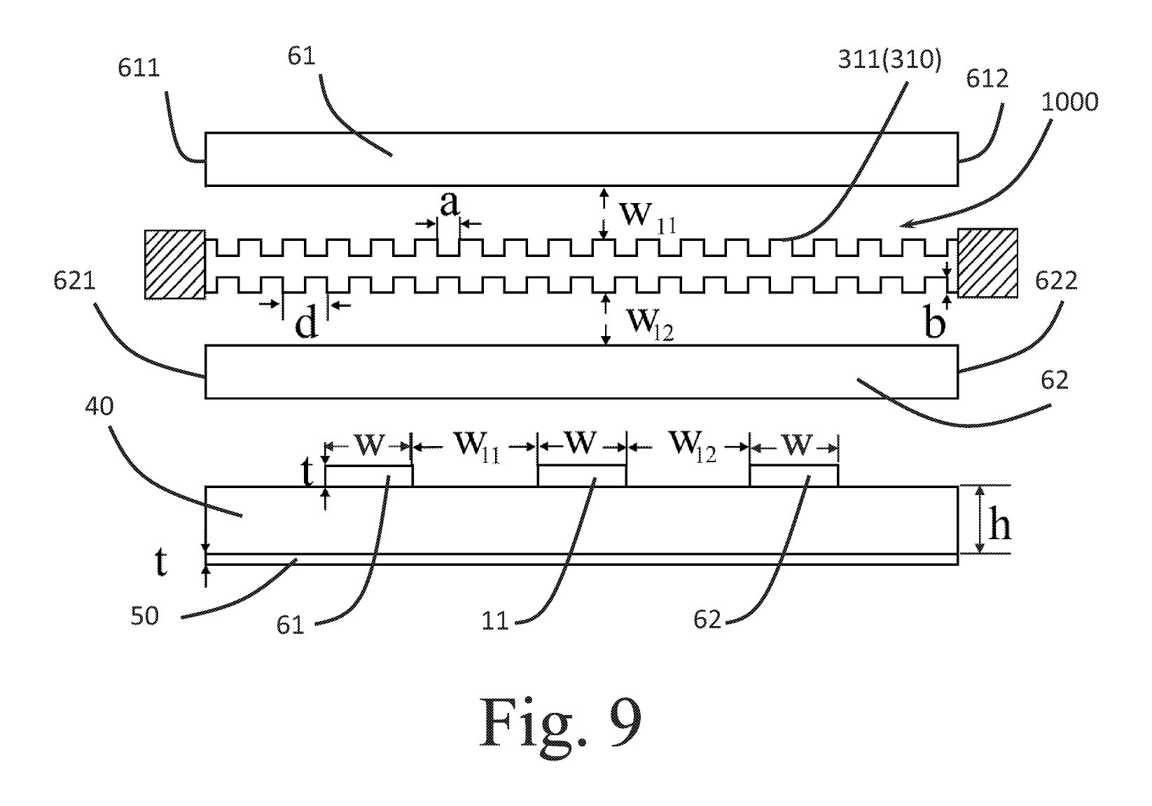

Please refer to FIG. 9, which illustrates a seventh embodiment where a crosstalk isolation structure 1000 is disposed between two microstrip transmission lines 61, 62. One end of the upper microstrip transmission line 61 has a first terminal 611 while the other end has a second terminal 612. Likewise, the one end of the lower microstrip transmission line 62 has a third terminal 621 while the other end has the fourth terminal 622. If there has no isolation measure between the two microstrip transmission lines 61, 62, the crosstalk effect induced by the electromagnetic energy generated from the upper microstrip transmission line 61 will interfere with the lower microstrip transmission line 62 seriously. However, when the crosstalk isolation structure 1000 is disposed between the two transmission lines 61, 62, the crosstalk effect between the two transmission lines 61, 62 will be effectively isolated. Accordingly, the crosstalk isolation structure of the present invention have effect on isolating and reducing crosstalk due to the electromagnetic energy generated from the upper and lower microstrip transmission lines 61, 62.

Please refer to FIG. 9, which illustrates an application using the crosstalk isolation structure 1000 shown in FIG. 1 for reducing the crosstalk effect, wherein the teeth structure 310 has rectangle projection 311. The upper part of the FIG. 9 is a top view of this application.

Please refer to the lower part of the FIG. 9, there includes a grounded layer 50 having thickness t, a substrate layer 40 with dielectric constant εᵣ and a height h, the conductive line 11 of the crosstalk isolation structure 1000, having a width w, and a thickness t. The substrate 40 is composed of dielectric or oxide or insulating materials. The grounded layer is composed of metal or other conductive materials. It should be noted that the crosstalk isolation structure in the seventh embodiment as shown in FIG. 9 can be replace by any isolation structure disclosed in this specification.

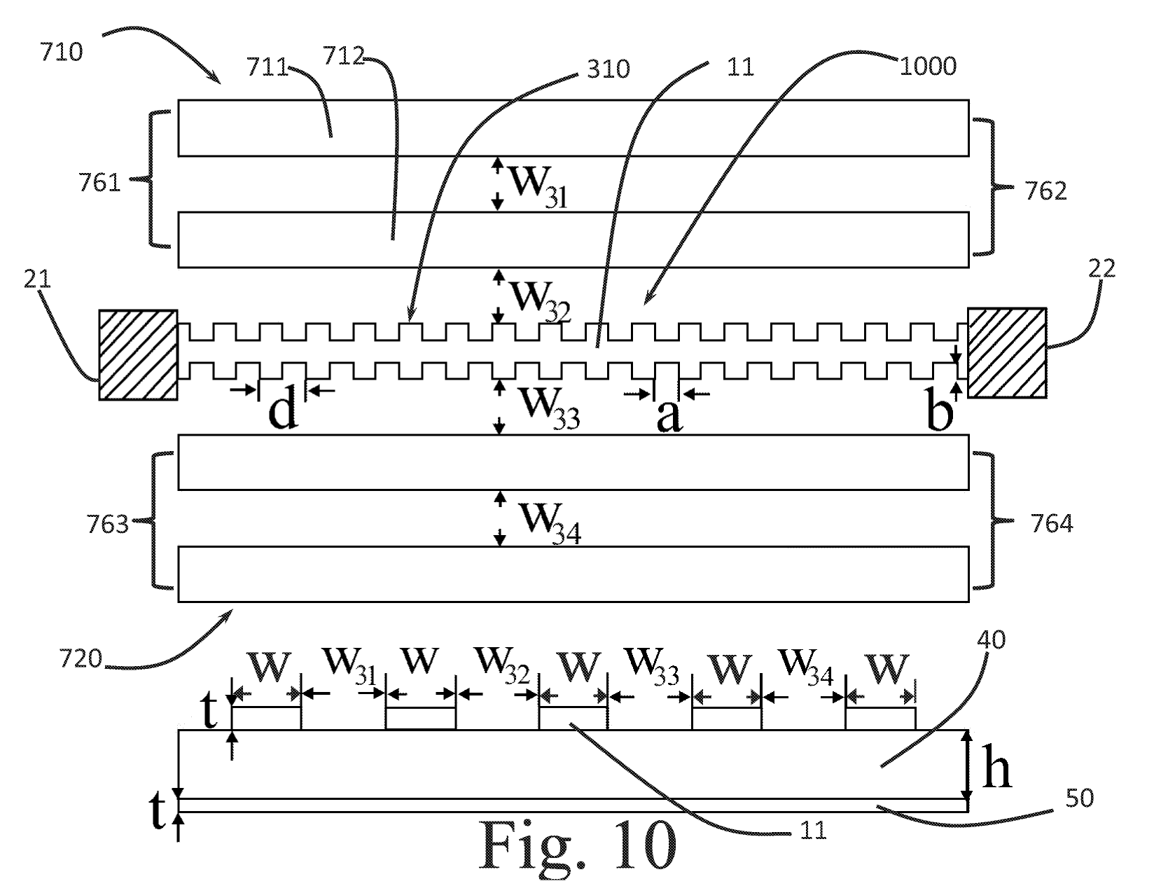

Please refer to FIG. 10, which illustrates an eighth embodiment where a crosstalk isolation structure 1000 is disposed between two differential microstrip transmission pairs 710, 720. Each differential microstrip transmission pair comprises two microstrip transmission lines, wherein one microstrip transmission line 711 transmits first transmission signal, and the other microstrip transmission line 712 transmits second transmission signal. The first and second transmission signals are complementary signals having 180-degree phase difference from each other.

The differential microstrip transmission pair 710 arranged at upper side has a first terminal 761 and a second terminal 762 at two ends while the differential micro strip transmission pair 720 arranged at the lower side has a third terminal 763 and fourth terminal 764. It is noted that if there has no isolation measure arranged between the two differential microstrip pairs 710, 720, the crosstalk due to the electromagnetic energy generated from the upper differential microstrip transmission pair 710 will obviously interfere with the lower differential microstrip transmission pair 720. However, if the crosstalk isolation structure 1000 is arranged between the two differential microstrip transmission pairs 710, 720, the crosstalk effect will be eliminated effectively. The crosstalk isolation structure of the present invention has effect on isolating and reducing crosstalk due to the electromagnetic energy.

Please refer to FIG. 10 and FIG. 1, the crosstalk isolation structure 1000 comprises a conductive line 11 and two resistors 21, 22. The conductive line 11 has a plurality of teeth structures 310 with periodic arrangement.

Please refer to the lower part of the FIG. 10, there is a grounded layer 50 with a thickness t, and a substrate layer 40 having dielectric constant εᵣ and a height h. Width of conductive line 11 of the crosstalk isolation structure 1000 is w, and width of each microstrip transmission line of these differential microstrip transmission pair 710, 720 is also w. These two differential microstrip transmission pairs 710, 720 are formed at the top layer of the substrate layer 40, and each microstrip transmission line is a metal layer or conductive layer with thickness t. The substrate 40 is composed of dielectric or oxide or insulating materials. The grounded layer is composed of metal or other conductive materials. In addition to the crosstalk isolation structure illustrated in present embodiment, it is should be noted that the crosstalk isolation structure 1000 in the eighth embodiment shown in FIG. 10 can be replace by any isolation structure disclosed in the specification.

In this embodiment, the distance W₃₁ between microstrip transmission line 711 and microstrip transmission line 712 is w. The distance W₃₂ between microstrip transmission line 712 and the conductive line 11 is also w. The distance W₃₃ between the conductive line 11 and the differential microstrip transmission pairs 720, and the distance W₃₄ between the two microstrip transmission lines in the differential microstrip transmission pairs 720 are also w. Although these distances are all w in this embodiment, but the invention doesn't limited these distance, in other embodiments, W₃₁, W₃₂, W₃₃, and W₃₄ may not equal to each other, one may arranged these structure with several suitable different distances.

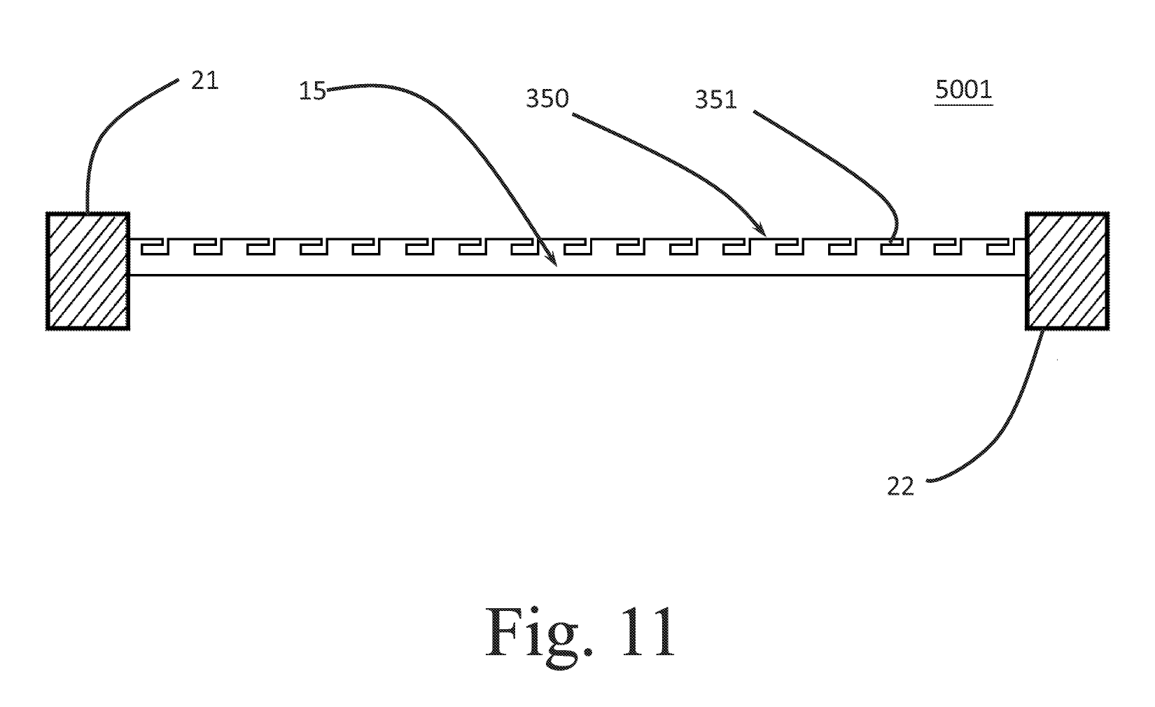

Please refer to FIG. 11, which illustrates a ninth embodiment of the present invention where each teeth structure 350 has an extension part 351. In the present embodiment, the crosstalk isolation structure 5001 comprises a conductive line 15 and two resistors 21, 22. The conductive line 15 comprises a plurality of teeth structures 350 with periodic arrangement. One resistor 21 is coupled to the one end of the conductive line 15 while the other resistor 22 is coupled to the other end of the conductive line 15. The two resistors 21, 22 are grounded and are impedance matched with the conductive line 15. The plurality of teeth structures 350 are formed at one lateral side of the conductive line 15 in a subwavelength configuration. Basically, the ninth embodiment is similar to the aforesaid fifth embodiment, whereas the difference is that the teeth structures 350 are formed at single side of the conductive line 15 in the ninth embodiment, while the teeth structures 350 are formed at two lateral side of the conductive line 15 in the fifth embodiment.

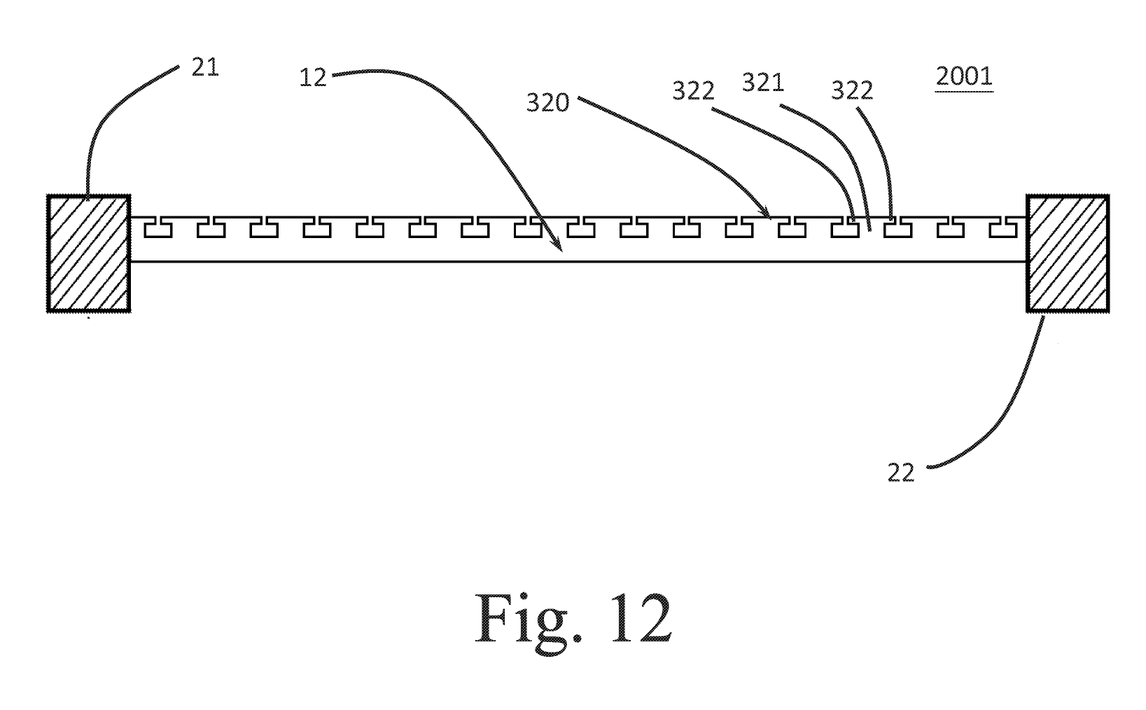

Please refer to FIG. 12, which illustrates a tenth embodiment of the present invention where each teeth structure 320 has two extension parts 322 extending along opposite directions. In the present embodiment, the crosstalk isolation structure 2001 comprises a conductive line 12 and two resistors 21, 22. The conductive line 12 comprises a plurality of teeth structures 320 with periodic arrangement. One resistor 21 is coupled to the one end of the conductive line 12 while the other resistor 22 is coupled to the other end of the conductive line 12. The two resistors 21, 22 are grounded and are impedance matched with the conductive line 12. The plurality of teeth structures 320 are formed at one lateral side of the conductive line 12 in a subwavelength configuration. Basically, the tenth embodiment is similar to the aforesaid second embodiment, and the difference is that the teeth structures 320 are formed at single side of the conductive line 12 in the tenth embodiment, while the teeth structures 320 are formed at two lateral sides of the conductive line 12 in the second embodiment.

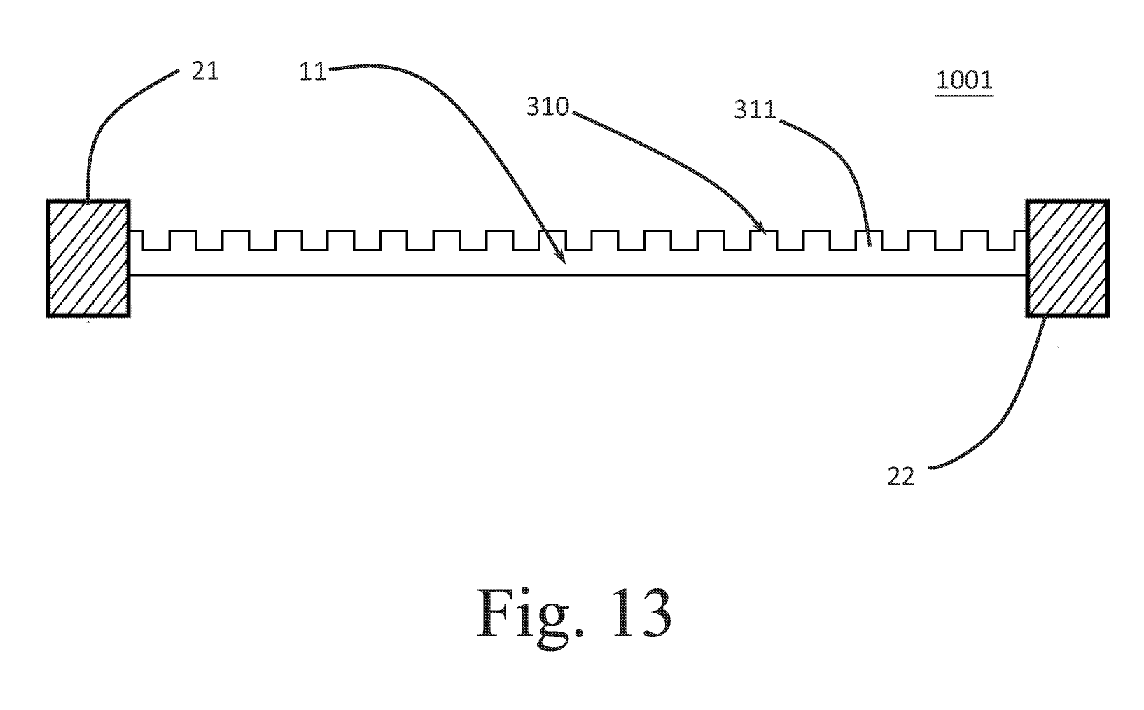

Please refer to FIG. 13, which illustrates an eleventh embodiment of the present invention where each teeth structure 310 has a rectangle projection 311. In the present embodiment, the crosstalk isolation structure 1001 comprises a conductive line 11 and two resistors 21, 22. The conductive line 11 comprises a plurality of teeth structures 310 with periodic arrangement. One resistor 21 is coupled to the one end of the conductive line 11 while the other resistor 22 is coupled to the other end of the conductive line 11. The two resistors 21, 22 are grounded and are impedance matched with the conductive line 11. The plurality of teeth structures 310 are formed at one lateral side of the conductive line 11 in a subwavelength configuration. Basically, the teeth structures 310 shown in eleventh embodiment are similar to the structures of aforesaid first embodiment, whereas the difference is that the teeth structures 310 are formed at single side of the conductive line 11 in the eleventh embodiment, while the teeth structures 310 are formed at two lateral sides of the conductive line 11 in the first embodiment.

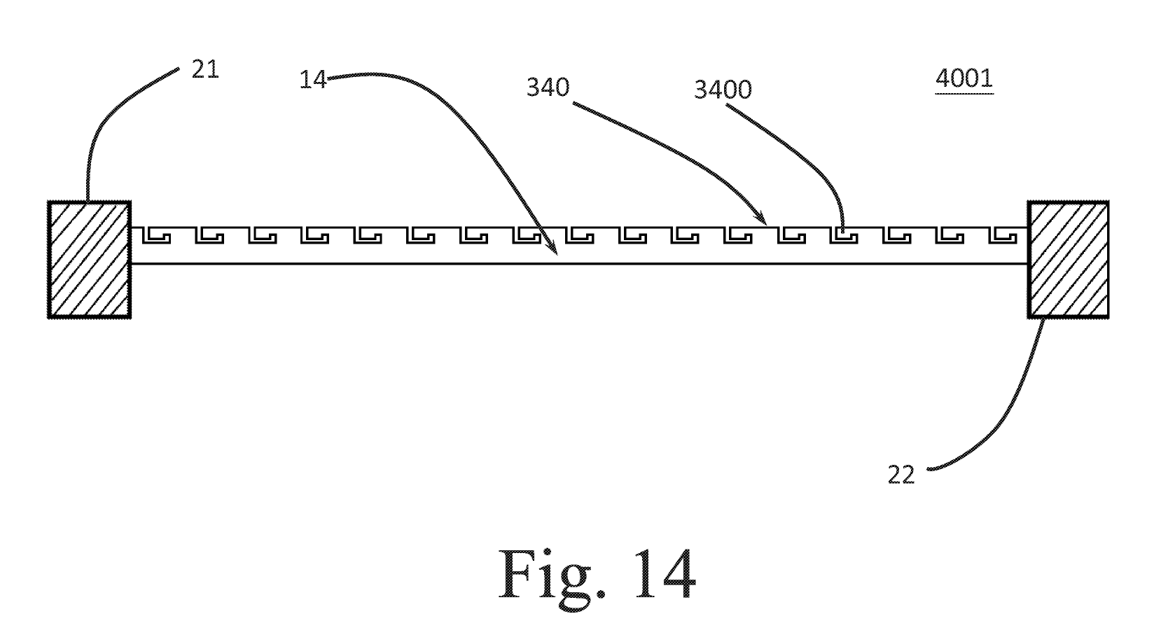

Please refer to FIG. 14, which illustrates a twelfth embodiment of the present invention where each teeth structure 340 has a J-shaped projection 3400. In the present embodiment, the crosstalk isolation structure 4001 comprises a conductive line 14 and two resistors 21, 22. The conductive line 14 comprises a plurality of teeth structures 340 with periodic arrangement. One resistor 21 is coupled to the one end of the conductive line 14 while the other resistor 22 is coupled to the other end of the conductive line 14. The two resistors 21, 22 are grounded and are impedance matched with the conductive line 14. The plurality of teeth structures 340 are formed at one lateral side of the conductive line 14 in a subwavelength configuration. Basically, the teeth structures 340 shown in twelfth embodiment are similar to the structures of aforesaid fourth embodiment, and the difference is that the teeth structures 340 are formed at single side of the conductive line 14 in the twelfth embodiment, while the teeth structures 340 are formed at two lateral sides of the conductive line 14 in the fourth embodiment.

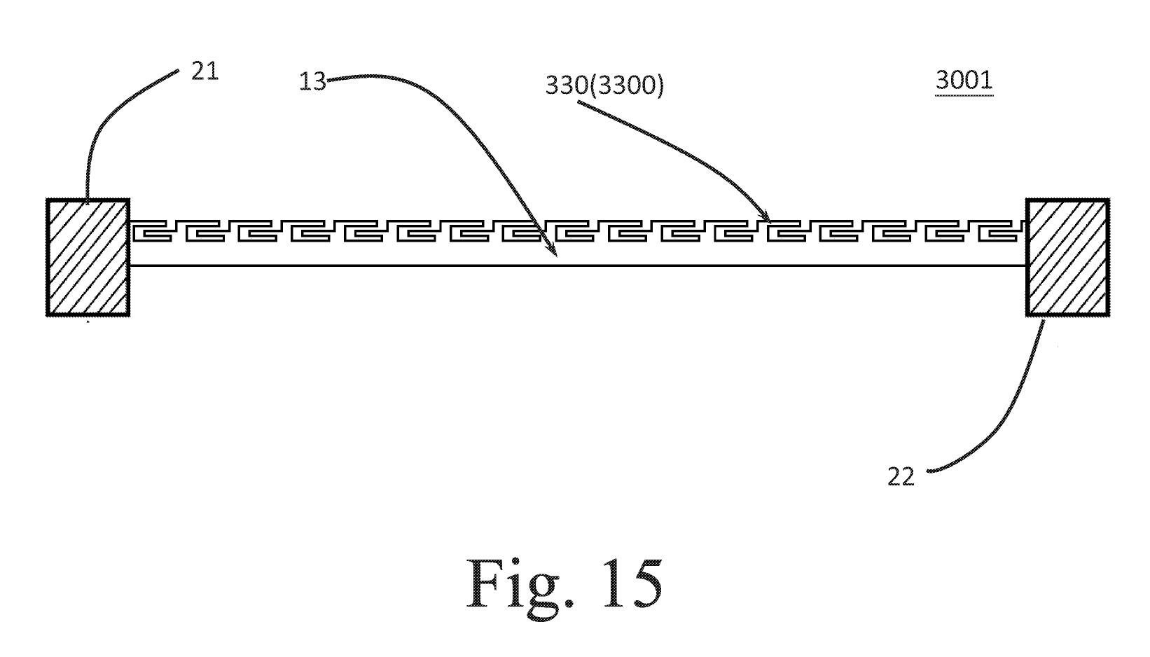

Please refer to FIG. 15, which illustrates a thirteenth embodiment where each teeth structure 330 has a Z-shaped projection 3300. In the present embodiment, the crosstalk isolation structure 3001 comprises a conductive line 13 and two resistors 21, 22. The conductive line 13 comprises a plurality of teeth structures 330 with periodic arrangement. One resistor 21 is coupled to the one end of the conductive line 13 while the other resistor 22 is coupled to the other end of the conductive line 13. The two resistors 21, 22 are grounded and are impedance matched with the conductive line 13. The plurality of teeth structures 330 are formed at one lateral side of the conductive line 13 in a subwavelength configuration. Basically, the teeth structures 330 shown in thirteenth embodiment are similar to the structures of aforesaid third embodiment, and the difference is that the teeth structures 330 are formed at single side of the conductive line 13 in the thirteenth embodiment, while the teeth structures 330 are formed at two lateral sides of the conductive line 13 in the third embodiment.

The crosstalk isolation structure of the present invention is provided for reducing crosstalk effect by a plurality of teeth with subwavelength configuration periodically formed at least one lateral side of a conductive line, wherein the subwavelength configuration is that a period length of the plurality of teeth structures is smaller than a wavelength of an electromagnetic signal generated by a crosstalk effect around the conductive line and the plurality of teeth structures are capable of eliminating the impingement of electromagnetic wave and isolating the electromagnetic field so that externally generated crosstalk effect can be effectively reduced or eliminated.

It should be noted that the source of crosstalk can be a single-ended transmission line or differential pair transmission lines or other type transmission line. In the embodiments shown in FIGS. 9 and 10, the crosstalk is from the conventional microstrip transmission lines without structures formed on the lateral sides thereof. Alternatively, the source of crosstalk can also be microstrip transmission line or differential microstrip transmission pair having a plurality of teeth structures with subwavelength configuration that are periodically formed on at least one lateral side of each microstrip transmission line. It should be noted that the source of crosstalk is not limited to the microstrip transmission line or differential microstrip transmission pair. The external source may be any signal source. Furthermore, the resistors 21, 22 respectively coupled to the two ends of the conductive line 11 are grounded and are impedance matched with the conductive line 11 so that the crosstalk or impingement of the electromagnetic energy can be grounded through the impedance matched resistors 21, 22 thereby achieving objectives of reducing crosstalk and restraining the impingement of electromagnetic wave.

The layout of abovementioned conductive line 11 can be, but should not be limited to, linear type, arc type, or nearly closed ellipse, circle, triangle, rectangle, or rhombus. It should be noted that the crosstalk isolation structure having conductive line and two resistors in the present invention can be formed on a circuit board or other dielectric layer for effectively reducing and isolating crosstalk effect and the impingement of electromagnetic wave between different signal sources such as microstrip line, or differential microstrip pair, for example.

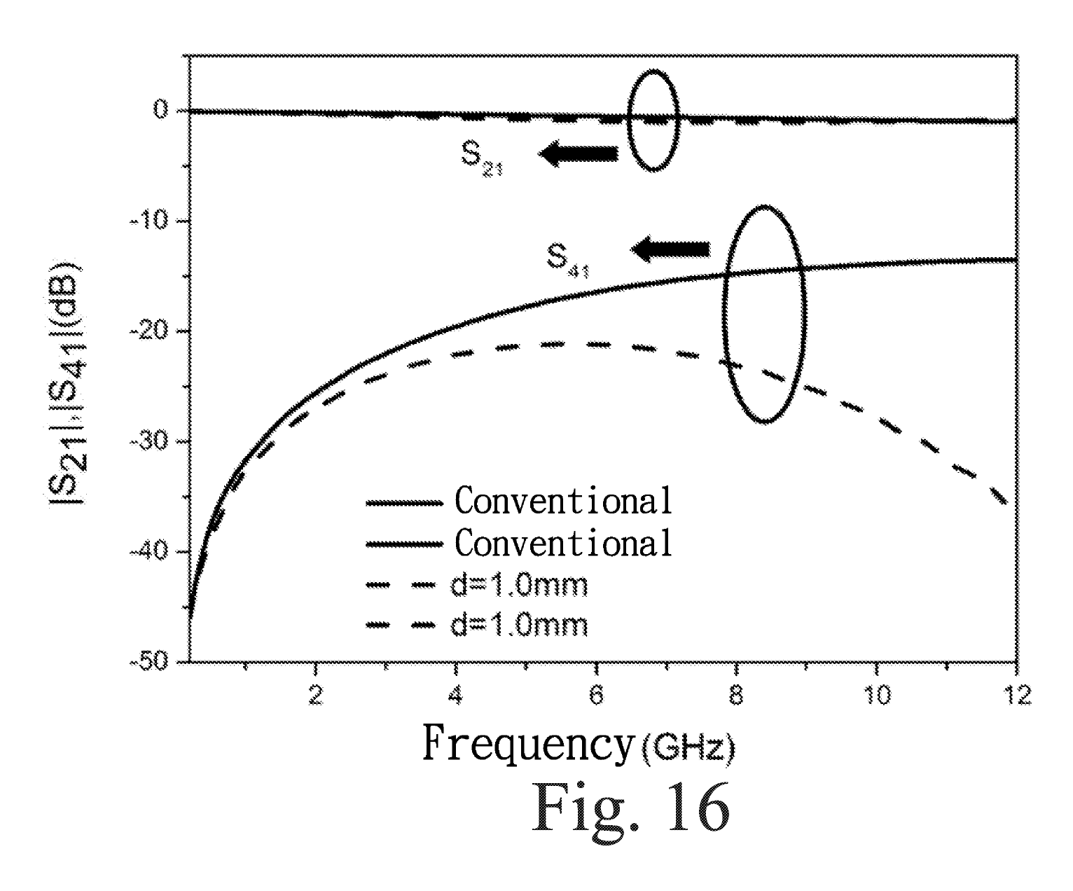

The present invention provides exemplary simulation graph as shown in FIG. 16 which illustrates crosstalk elimination result respectively in circuit having crosstalk isolation structure and circuit without crosstalk isolation structure, wherein parameter S represents the simulation of crosstalk elimination effect. It should be noted that the crosstalk isolation structure utilized to simulate the crosstalk elimination shown in FIG. 16 is the structure shown in FIG. 9 wherein a plurality of teeth structures having rectangle projections 311 are formed at the two lateral sides of the conductive line 11 arranged between two micro strip transmission lines 61, 62. The plurality of teeth structures 310 has a subwavelength configuration arrangement whereby the crosstalk effect between the upper and lower microstrip transmission lines 61, 62 can be eliminated. In the layout shown in FIG. 9, the dielectric constant εᵣ is 3.55, the width W of the conductive line 11 is 1.64 mm, the interval W₁₁ and W₁₂ between the conductive line 11 and the upper and lower transmission lines 61, 62 is 1.64 mm, the period length d of the teeth structures 310 is 1.0 mm which is twice of the width a of the recess between two adjacent projections 311, the length b of the rectangle projections 311 is 0.492 mm, the thickness t of the metal layer 50 is 0.035 mm and the thickness h of the substrate 40 is 0.73 mm.

In the FIG. 16, S₂₁ represents the transmission coefficient transmitted from the first terminal 611 to second terminal 612 while S₄₁ represents the transmission coefficient of the crosstalk from the first terminal 611 to fourth terminal 622. From the simulation result shown in FIG. 16, there has no significant difference between the microstrip transmission lines 61, 62 having crosstalk isolation structure 1000 disposed there between, and microstrip transmission lines 61, 62 without crosstalk isolation structure when the frequency of S₂₁ varies from 0-12 GHz; however, FIG. 16 shows that the arrangement of the crosstalk isolation structure 1000 has obvious improvement on eliminating crosstalk S₄₁. Taking the frequency at 12 GHz as an example, when there has no crosstalk isolation structure arranged between the two microstrip transmission lines 61, 62, illustrated as the solid line curve in FIG. 16, the S₄₁ is −13.56 dB; however, when there has a crosstalk isolation structure 1000 arranged between the two microstrip transmission lines 61, 62, illustrated as the dash line curve in FIG. 16, the S₄₁ is −36.2667 dB. Accordingly, it is clear that the crosstalk isolation structure 1000 has remarkable effect on eliminating the crosstalk effect induced between the two microstrip transmission lines 61, 62.

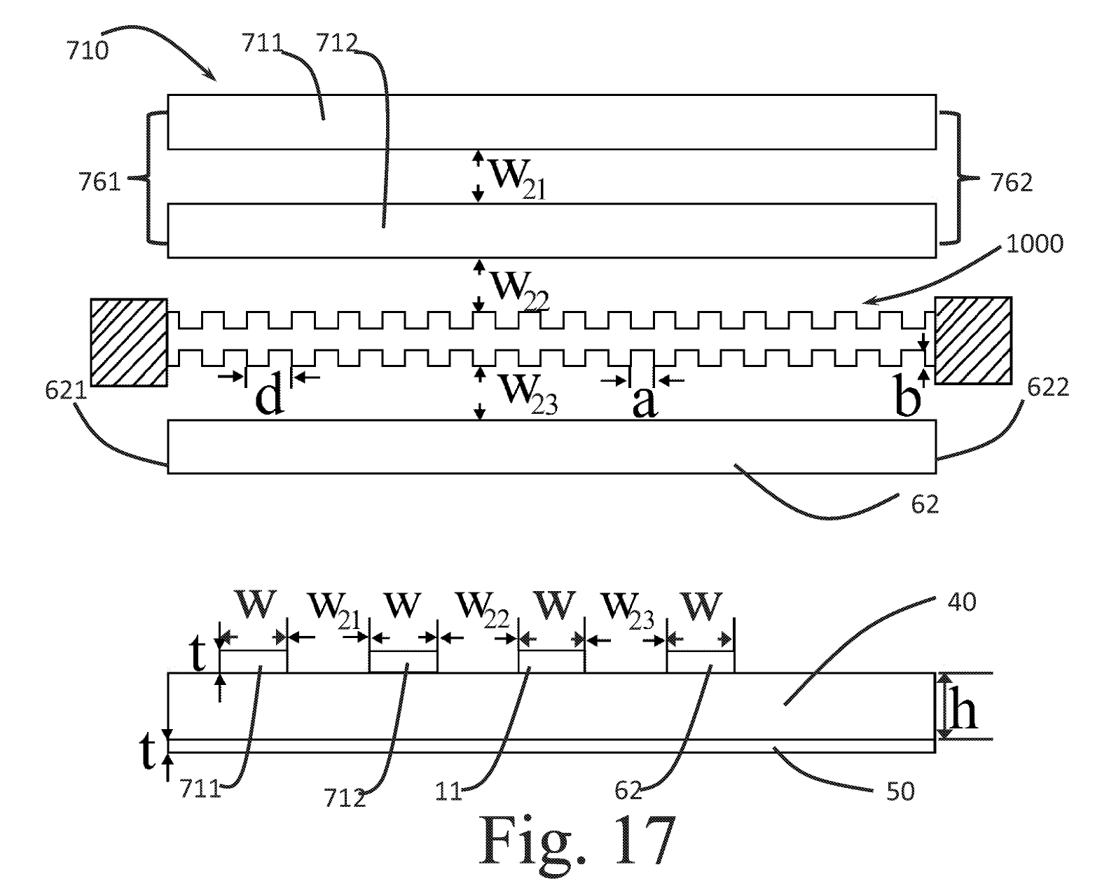

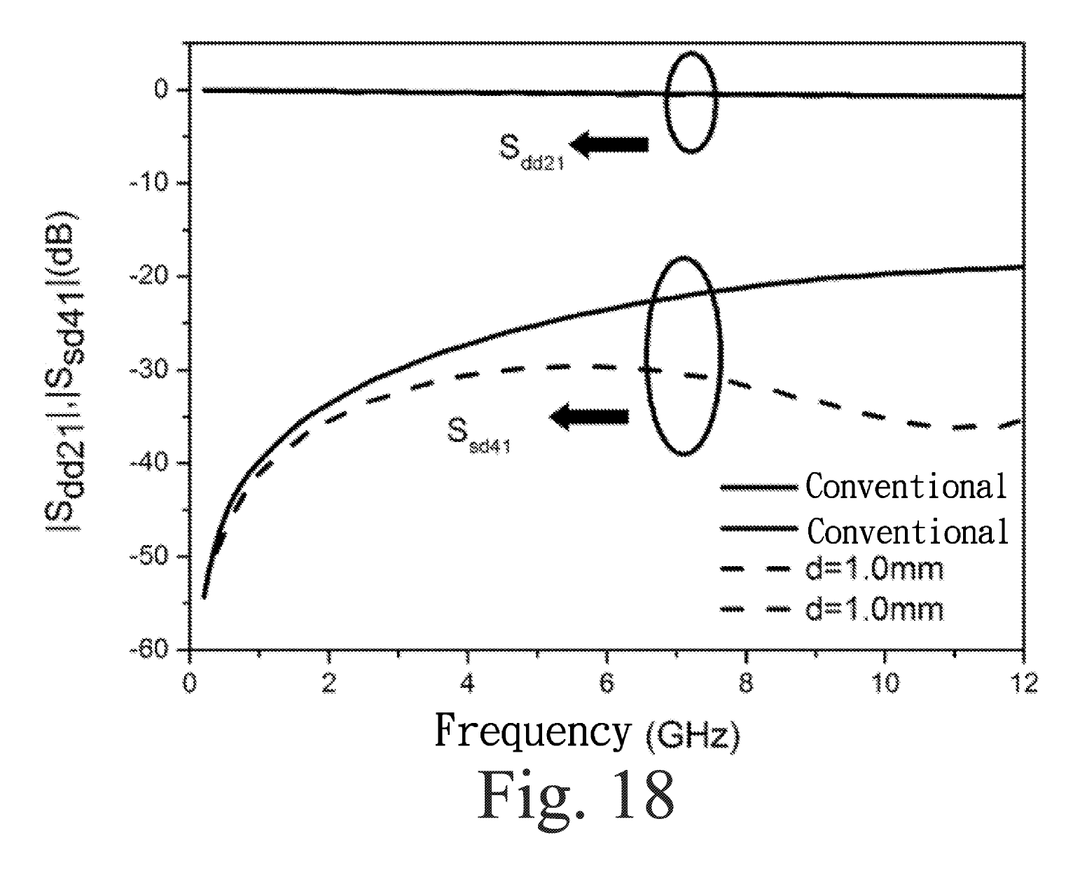

The present invention provides alternative exemplary simulation graph shown in FIG. 18 which illustrates crosstalk elimination result respectively in circuit having crosstalk isolation structure and circuit without crosstalk isolation structure, wherein parameter S represents the simulation of crosstalk elimination effect. It should be noted that the crosstalk isolation structure utilized to simulate the crosstalk elimination result shown in FIG. 18 is the structure shown in FIG. 17 wherein the crosstalk isolation structure 1000 has the subwavelength configuration for eliminating crosstalk effect between the differential microstrip transmission pair 710 arranged at one side of the crosstalk isolation structure 1000 and single microstrip transmission line 62 arranged at the other side of the crosstalk isolation structure 1000. It should be noted that the material for making the circuit layout and crosstalk isolation structure 1000 shown in FIG. 17 is the same, but the invention is not limited to this feature.

In the embodiment shown in FIG. 17, the differential microstrip transmission pair 710 has two microstrip transmission lines 711, 712 wherein one microstrip transmission line 711 transmits a first transmission signal and the other microstrip transmission line 712 transmits a second transmission signal. The first and second transmission signals are complementary signals having 180 degree phase difference from each other. The differential microstrip transmission pair 710 has a first terminal 761 and a second terminal 762. The microstrip transmission line 62 has a third terminal 621 and a fourth terminal 622. In the present embodiment shown in FIG. 17, it should be noted that the interval W₂₁ between the microstrip transmission lines 711, 712, the interval W₂₂ between the microstrip transmission line 712 and crosstalk isolation structure 1000, and the interval W₂₃ between the crosstalk isolation structure 1000 and microstrip transmission line 62 are the same as each other and the value thereof is 1.64 mm. The simulation result of the crosstalk elimination about the circuit layout having the differential micro strip transmission pair 710 and the single microstrip transmission line 62 is shown in FIG. 18.

In the FIG. 18, S_{dd21} represents the transmission coefficient transmitted from the first terminal 761 to second terminal 762 in the differential microstrip transmission pair 710 including first and second transmission lines 711, 712 while S_{sd41} represents the transmission coefficient of the crosstalk from the first terminal 761 of the differential microstrip transmission pair 710 to fourth terminal 622 of the microstrip transmission line 62. From the simulation result shown in FIG. 18, there has no significant difference between the circuit layout having crosstalk isolation structure disposed between the differential microstrip transmission pair 710 and microstrip transmission line 62, and the circuit layout without crosstalk isolation structure 1000 between the differential microstrip transmission pair 710 and microstrip transmission line 62 when the frequency of S_{dd21} varies from 0-12 GHz; however, FIG. 18 shows that the arrangement of the crosstalk isolation structure 1000 has obvious improvement on elimination of the crosstalk S_{sd41}. Taking the frequency at 12 GHz as an example, when there has no crosstalk isolation structure arranged between the differential microstrip transmission pair 710 and the microstrip transmission line 62, illustrated as the solid line curve in FIG. 18, the S_{sd41} is −18.99 dB; however, when there has crosstalk isolation structure 1000 arranged between the differential microstrip transmission pair 710 and the microstrip transmission line 62, illustrated as the dash line curve in FIG. 18, the S_{sd41} is −35.37 dB. Accordingly, it is clear that the crosstalk isolation structure 1000 has remarkable effect on eliminating the crosstalk induced between the differential microstrip transmission pair 710 and the microstrip transmission line 62.

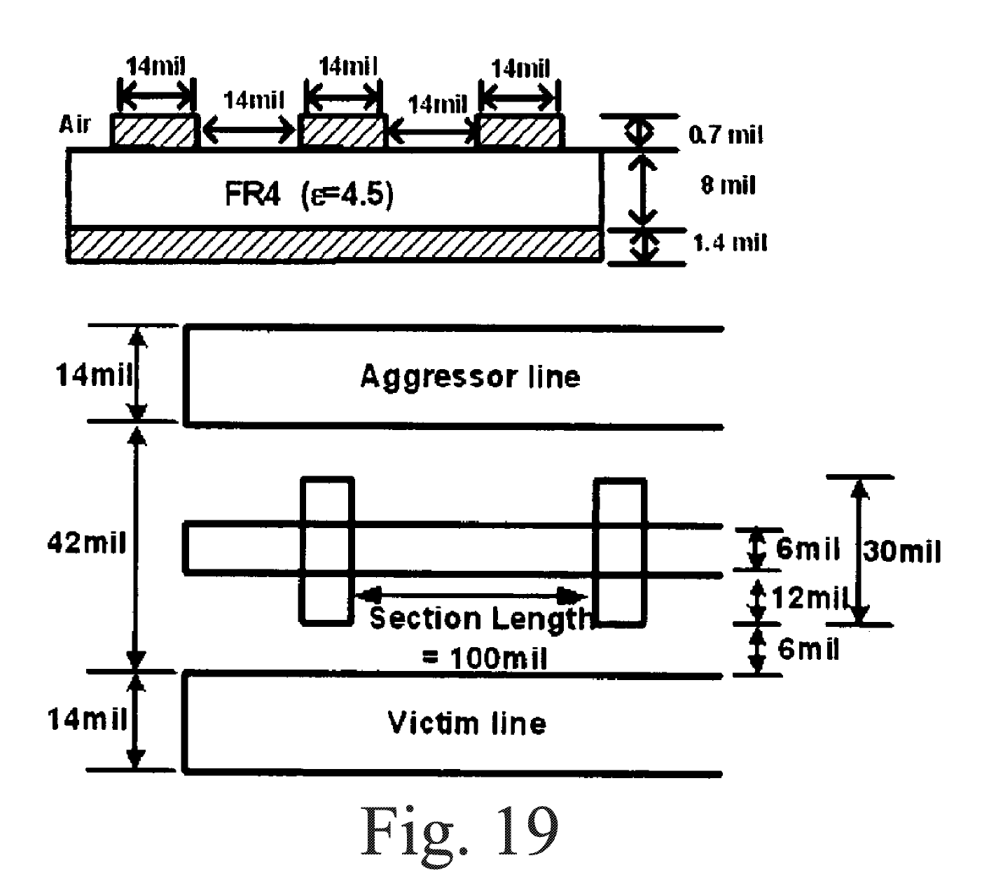

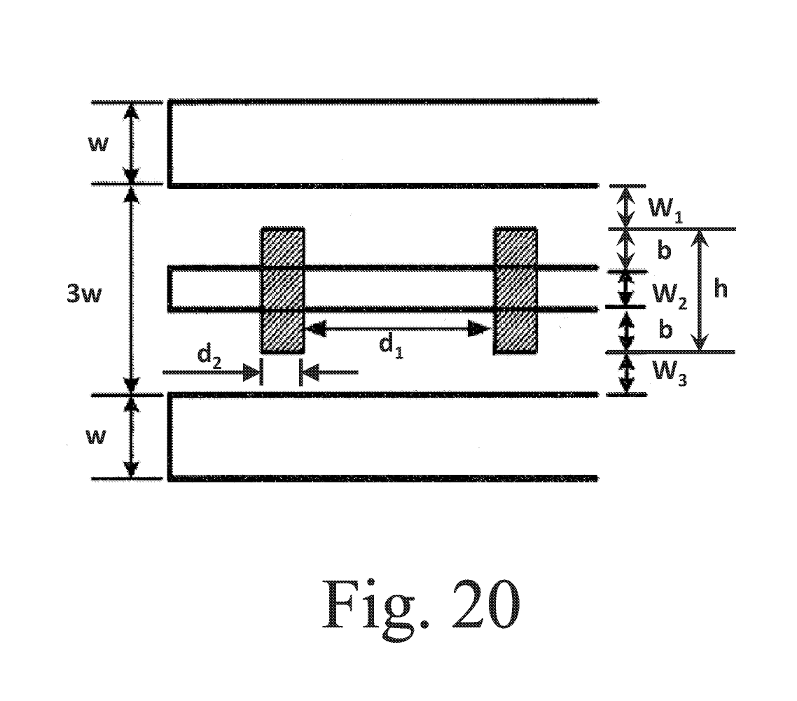

The isolation effect of magnetic field is varied with the depth variation of the teeth structures and the distance between the teeth structures and the transmission line. These conditions can also influence the isolation effect between transmission lines. Please refer to FIGS. 19 and 20, Park disclosed that d₁=100 mil, b=12 mil, and W₁=W₂=6 mil. On the other words, h=2b+W₂, and W₁/(W₁+b)=⅓. Because Park combining subwavelength will increase the crosstalk between the crosstalk isolation structure, the fifteenth embodiment of the present invention discloses that a crosstalk isolation structure with W₁/(W₁+b)>⅓, or on the other words, b/(W₁+b)<⅔ to distinguish the structure of Park combining subwavelength.

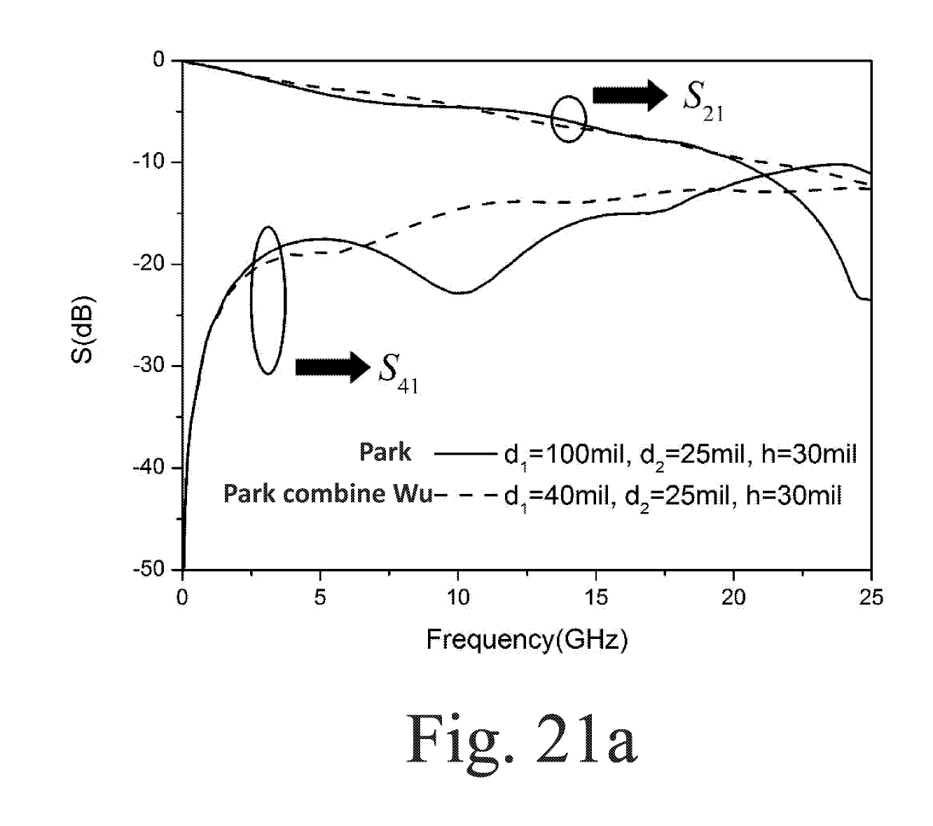

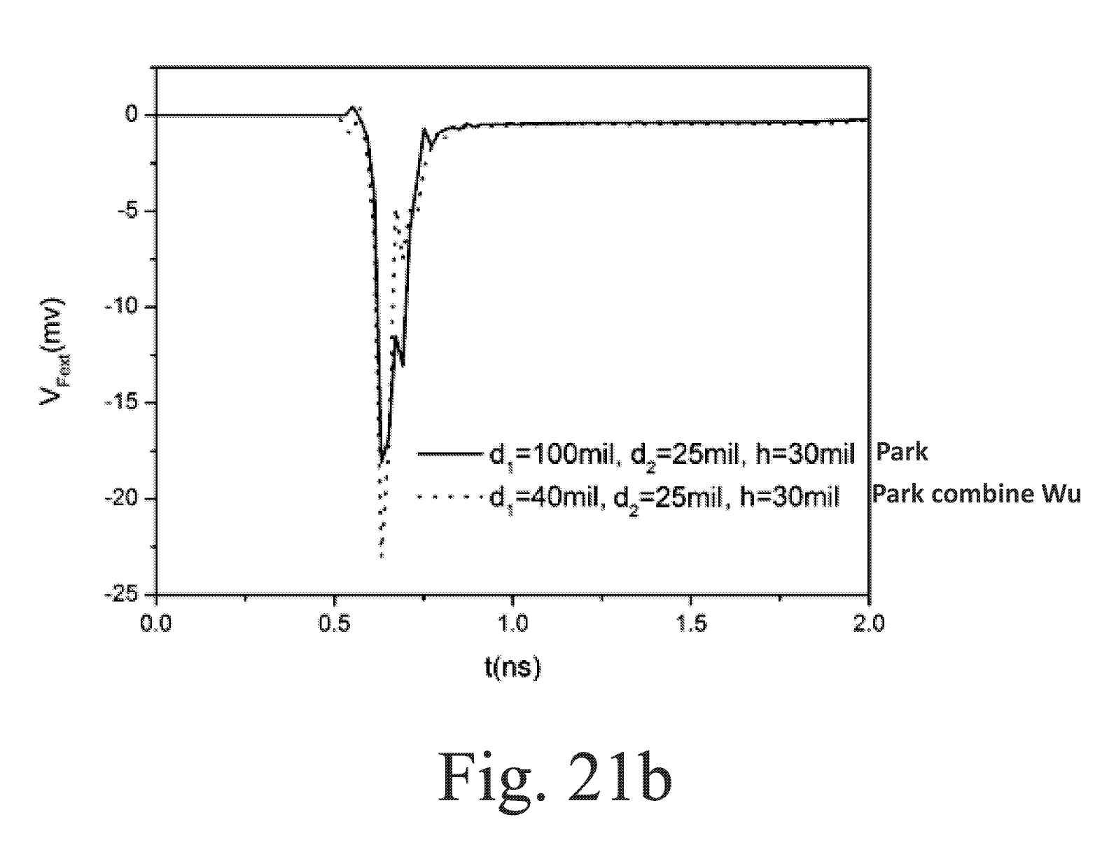

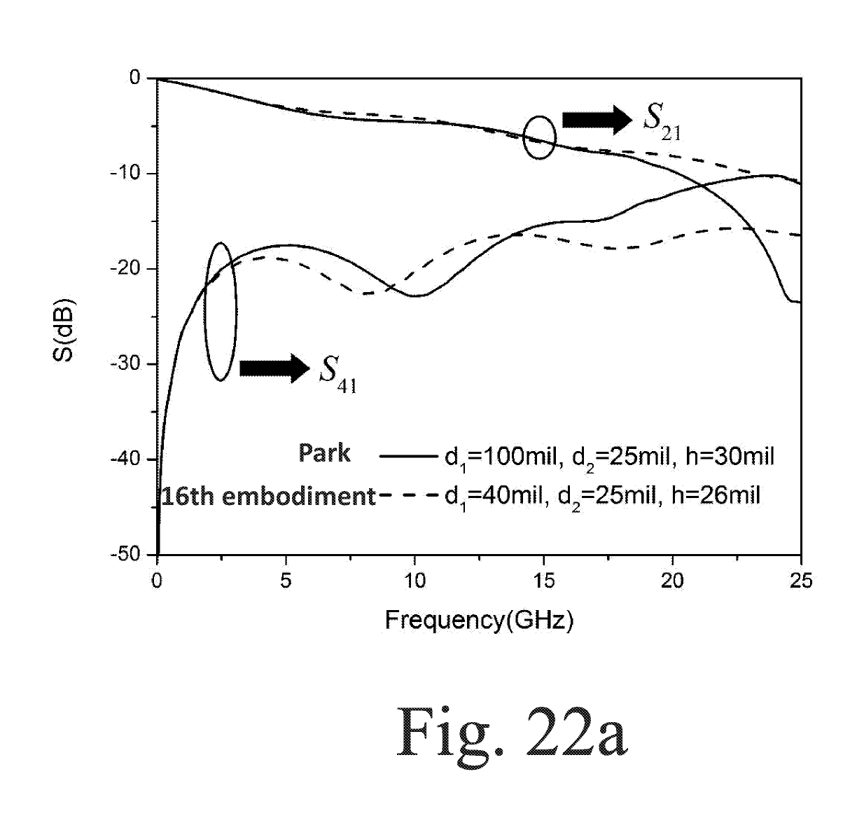

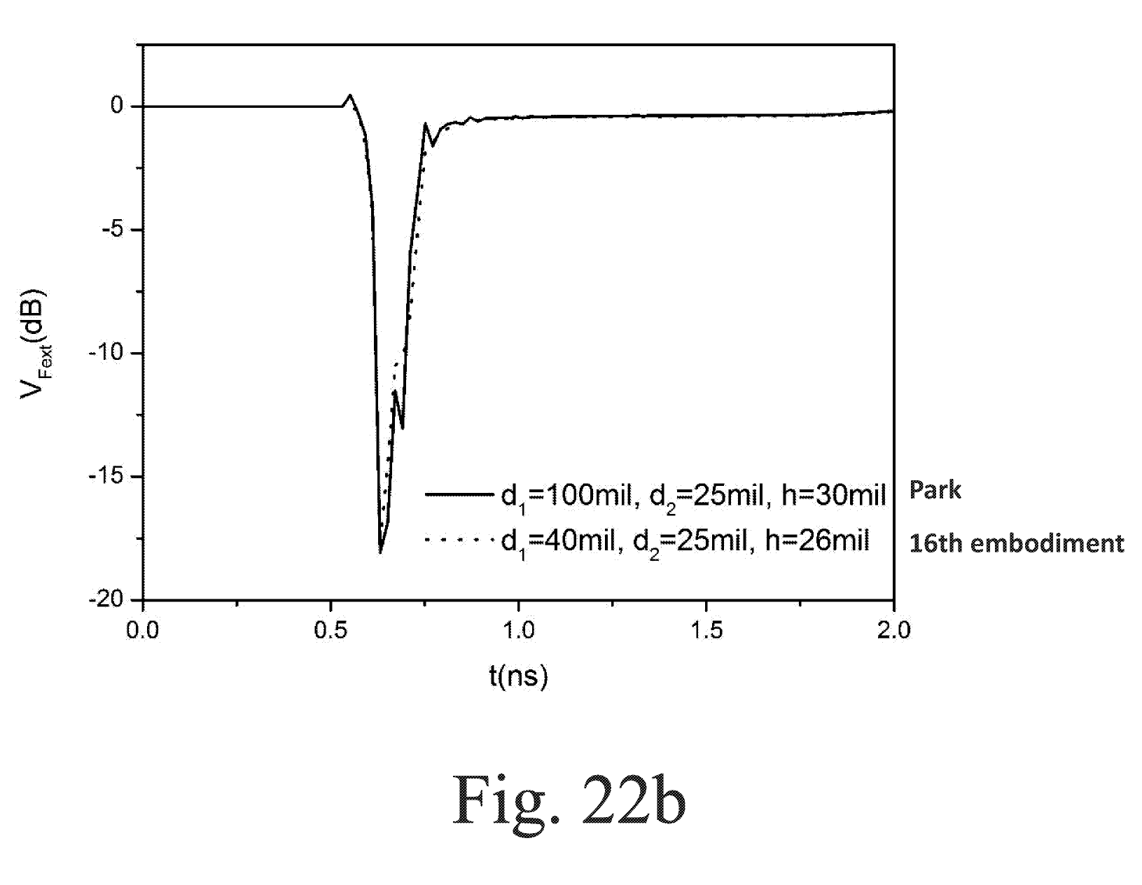

Please refer to FIGS. 22a and 22b, in the sixteenth embodiment of the invention, if we choice h=26 mil, and W₂=6 mil, on the other words, b=10 mil and W₁=8 mil. That is W₁/(W₁+b)= 4/9 or b/(W₁+b)= 5/9. The other condition is the same with the example of Park combining with Wu, on the other words, we shorter the depth b of the teeth structure in this sixteenth embodiment. The width w of the transmission line is 14 mil. The relation that W₁/w of this embodiment is 4/7. Comparing to Park's simulation result in FIGS. 22a and 22b, and the result of Park combining Wu in FIG. 21a, 21b, we find that when W₁/(W₁+b)≥ 4/9, b/(W₁+b)≤ 5/9, or W₁/w≥ 4/7, the crosstalk is smaller and better than that of Park combining Wu.

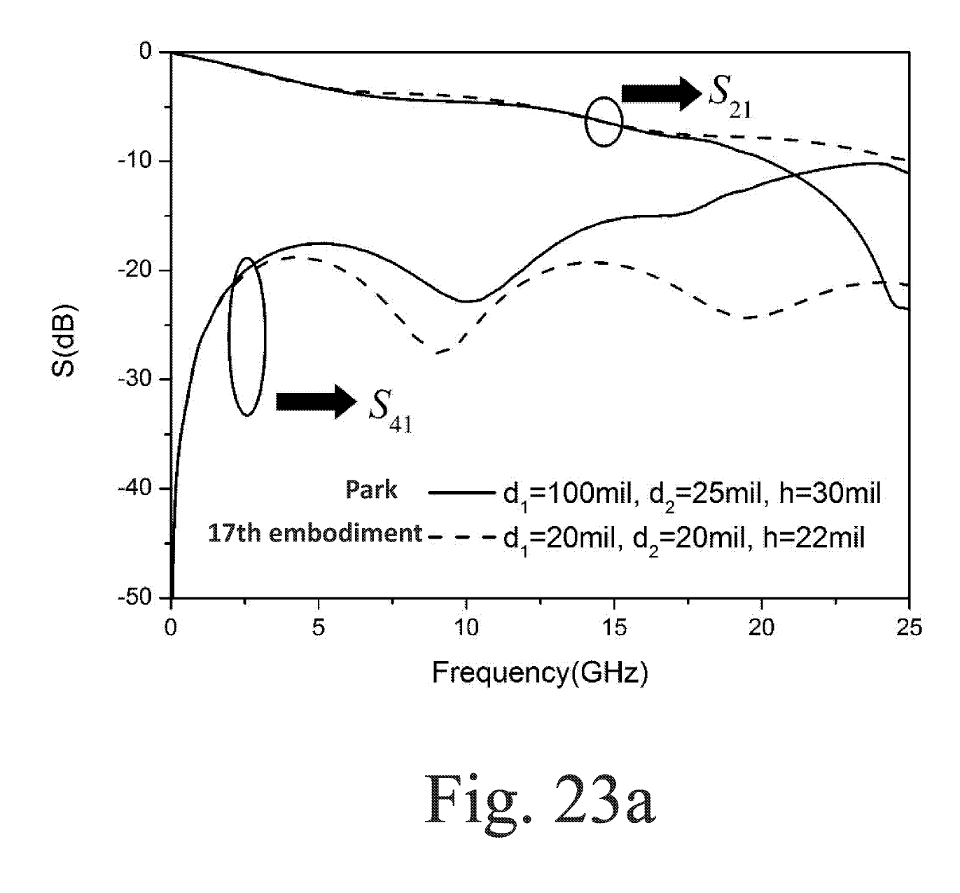

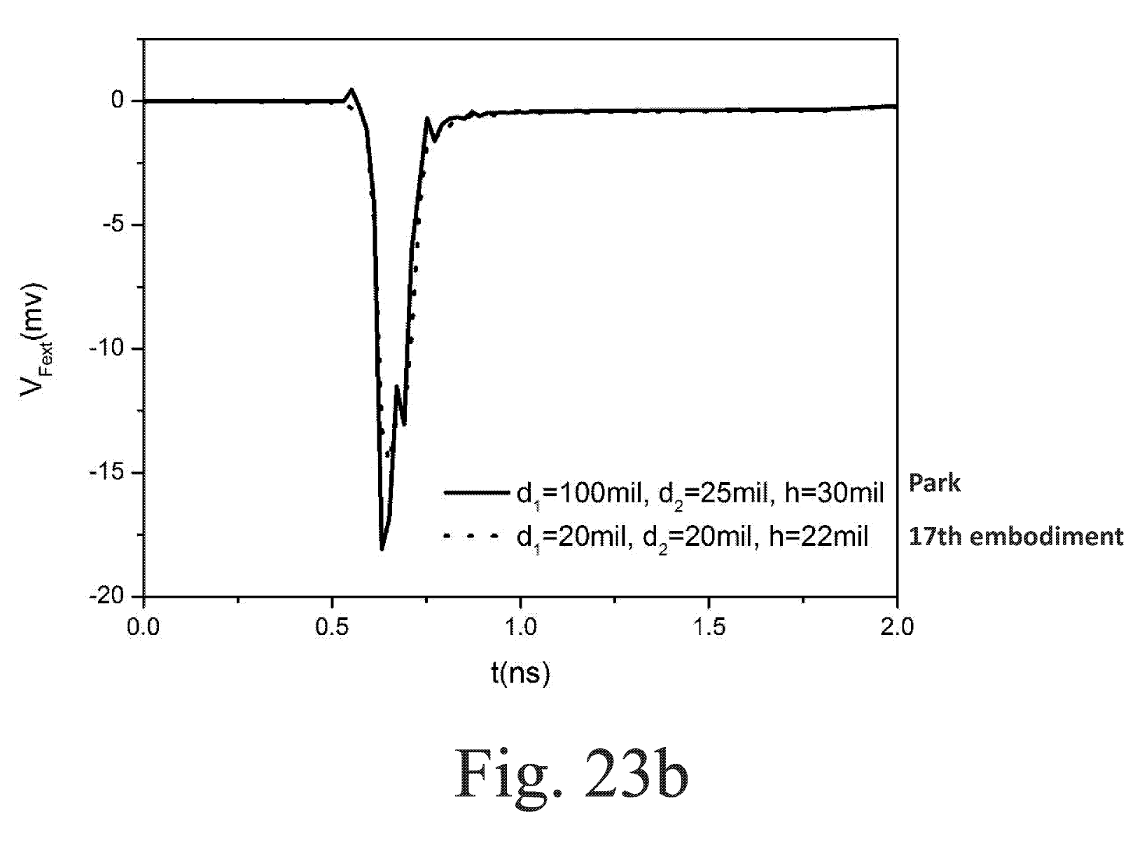

Please refer to FIGS. 23a and 23b, in the seventeenth embodiment of the invention, if we choice d₁=20 mil, d₂=20 mil, h=22 mil, and W₂=6 mil, on the other words, b=8 mil and W₁=10 mil. That is W₁/(W₁+b)= 5/9 or b/(W₁+b)= 4/9. The other condition of the seventeenth embodiment is the same with the example of Park combining with Wu, on the other words, we shorter the depth b of the teeth structure again in this seventeenth embodiment. The width w of the transmission line is 14 mil. The relation that W₁/w of this embodiment is 5/7. Comparing to Park's simulation result in FIGS. 23a and 23b, and the result of Park combining Wu in FIG. 21a, 21b, we find that when W₁/(W₁+b)≥ 5/9, b/(W₁+b)≤ 4/9, or W₁/w≥ 5/7, the crosstalk is smaller and better than that of Park.

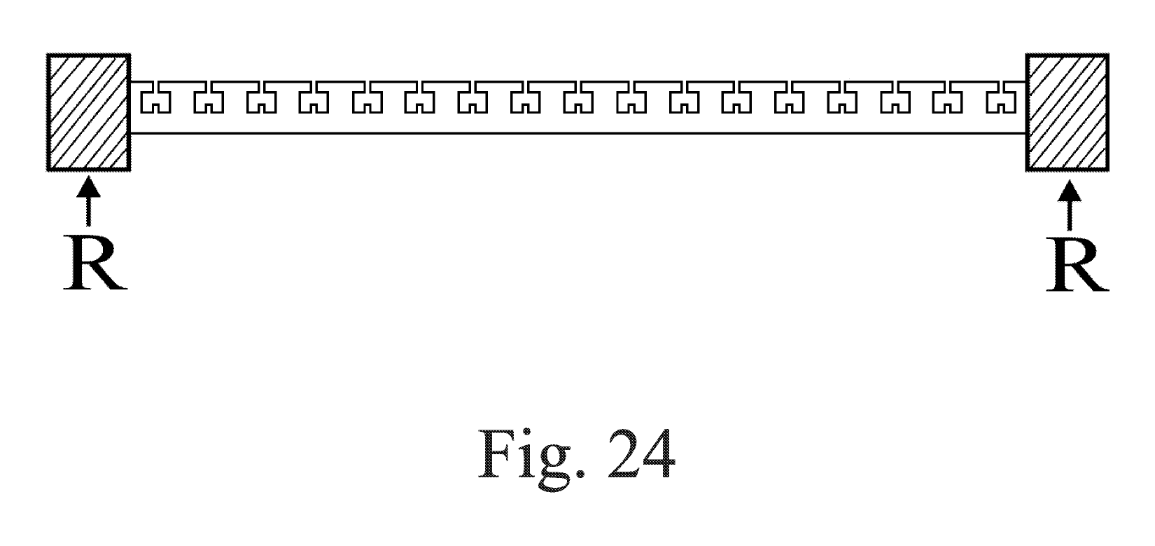

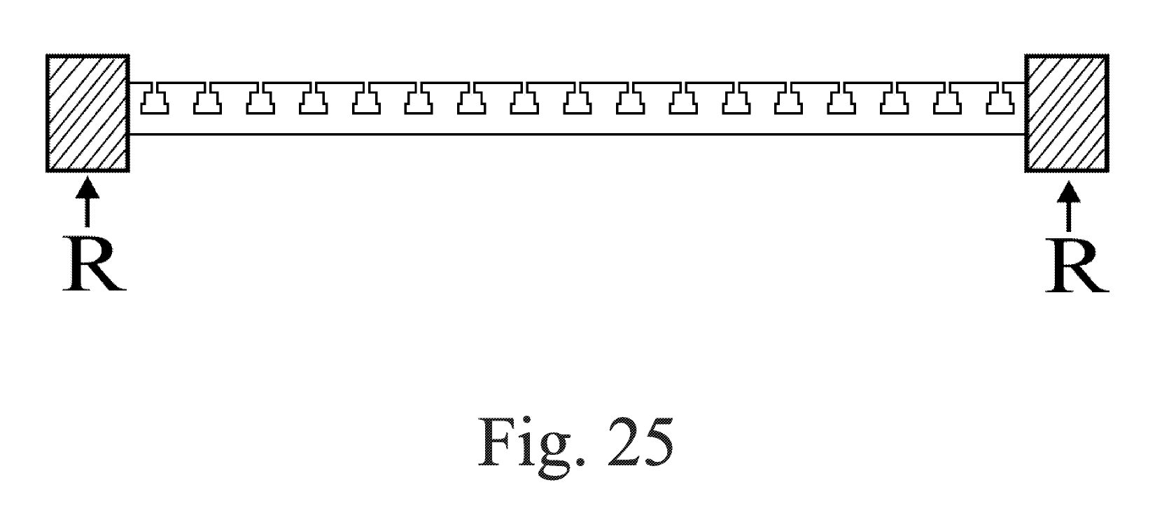

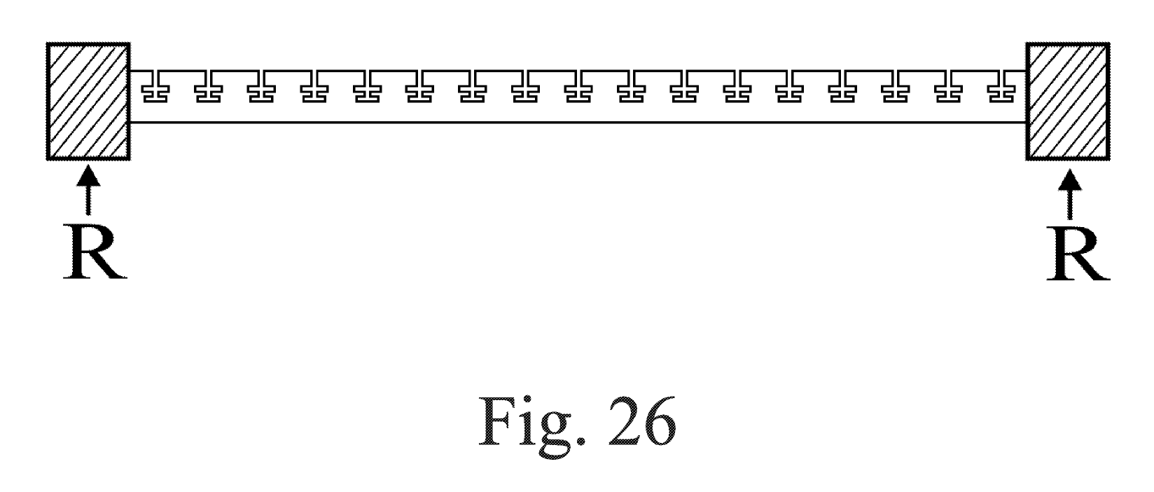

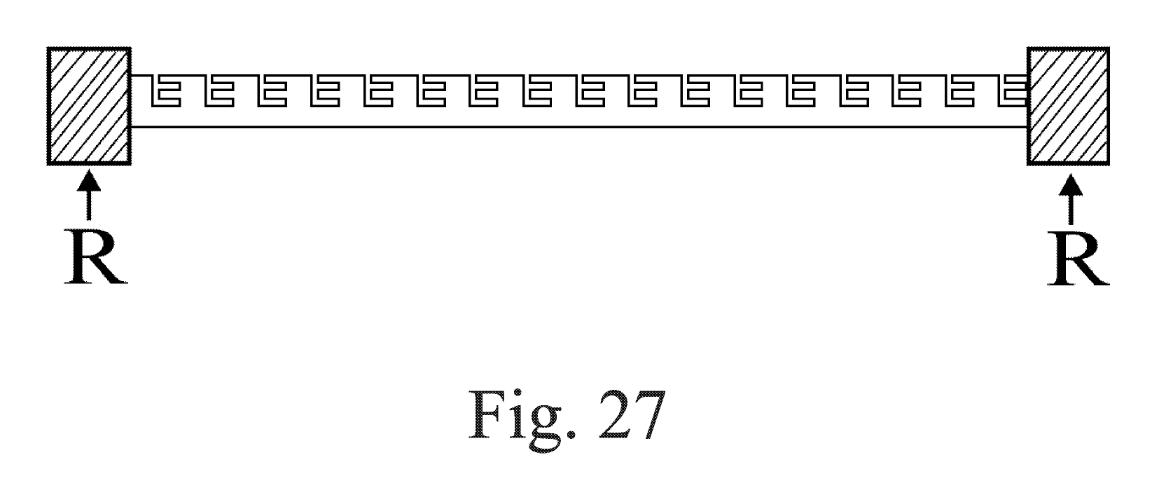

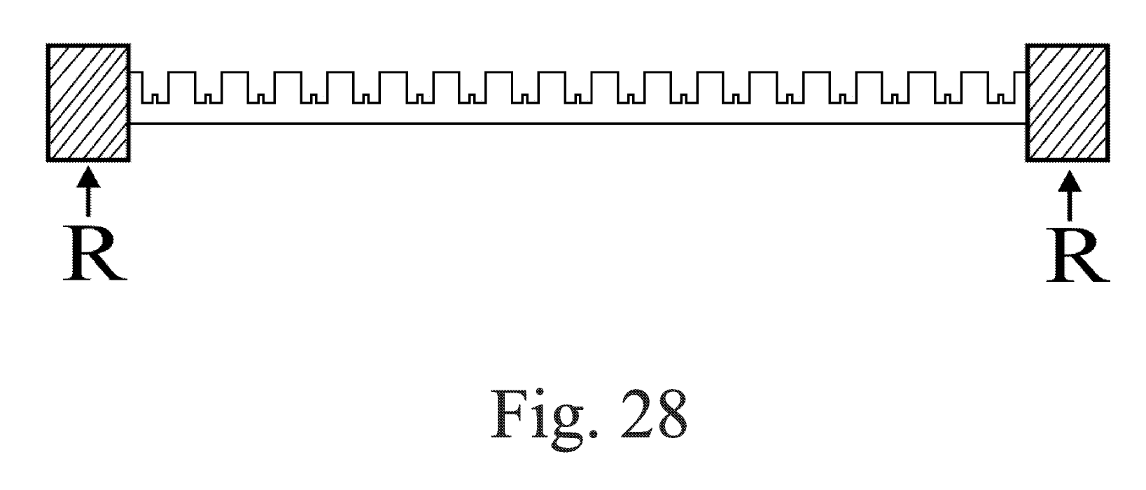

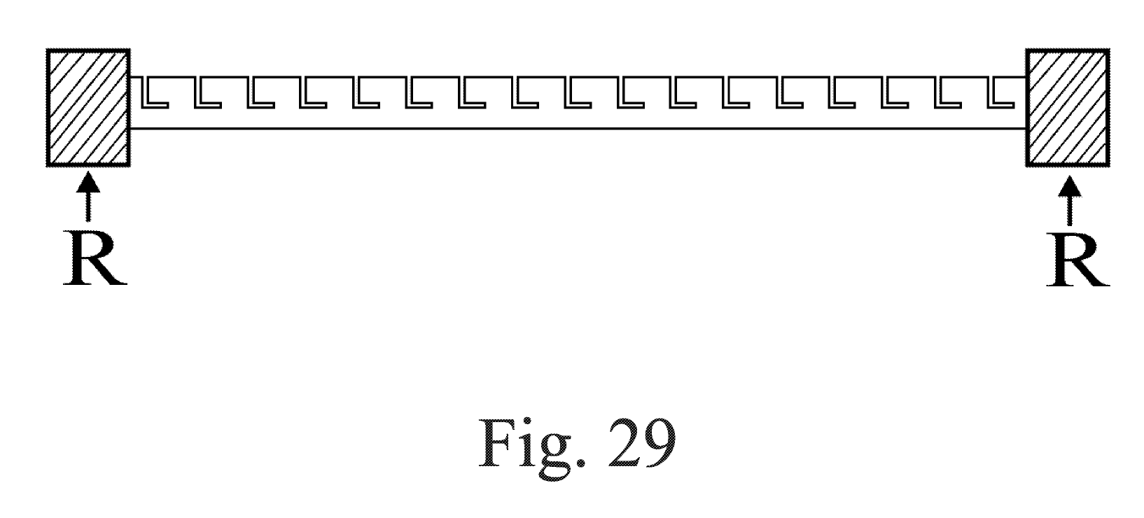

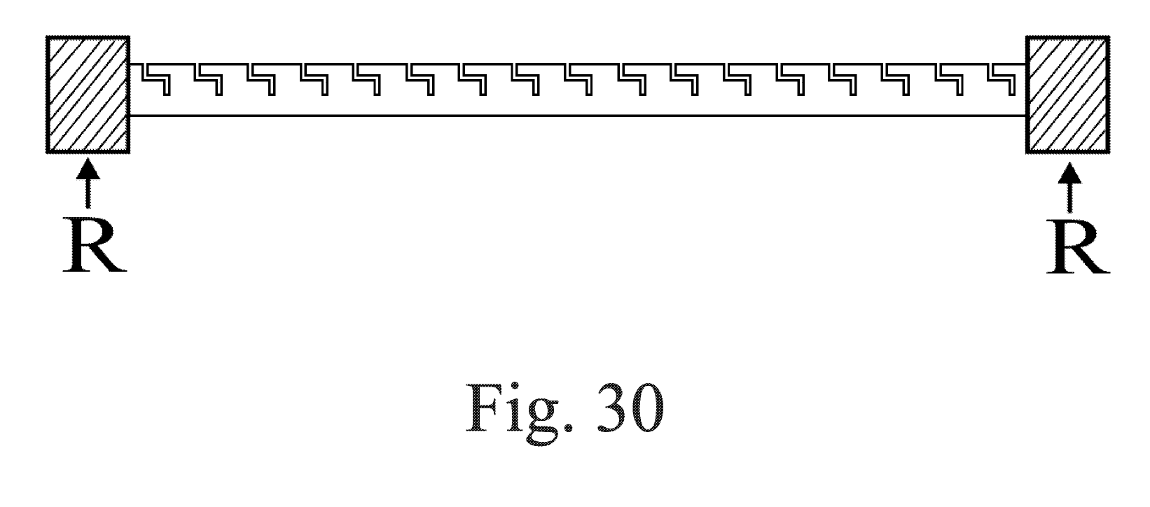

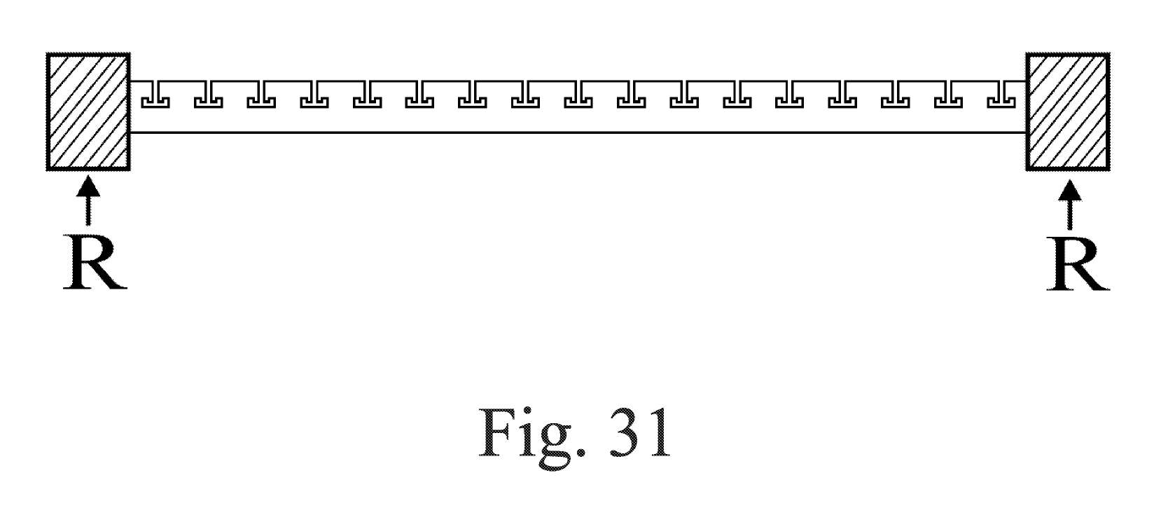

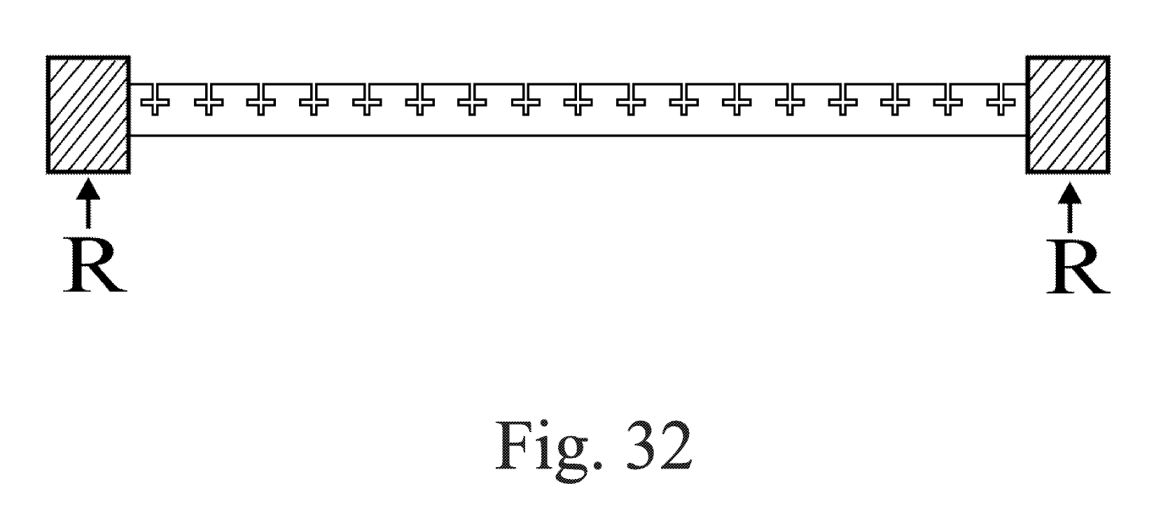

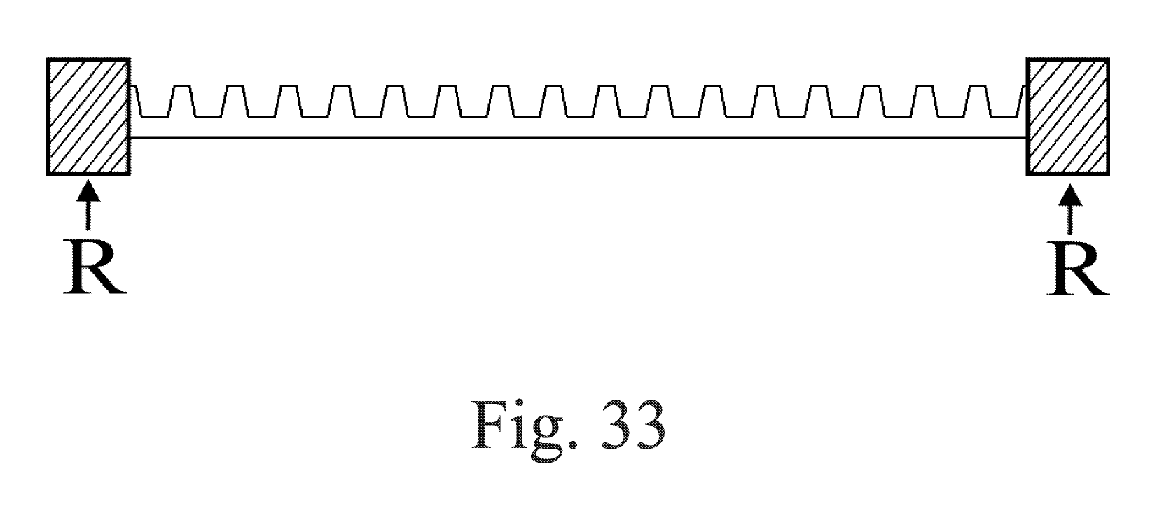

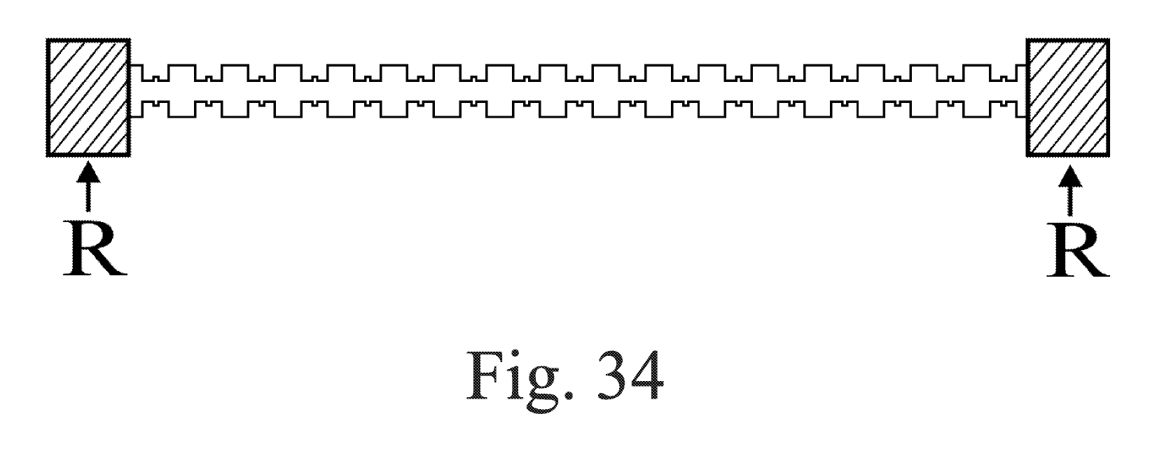

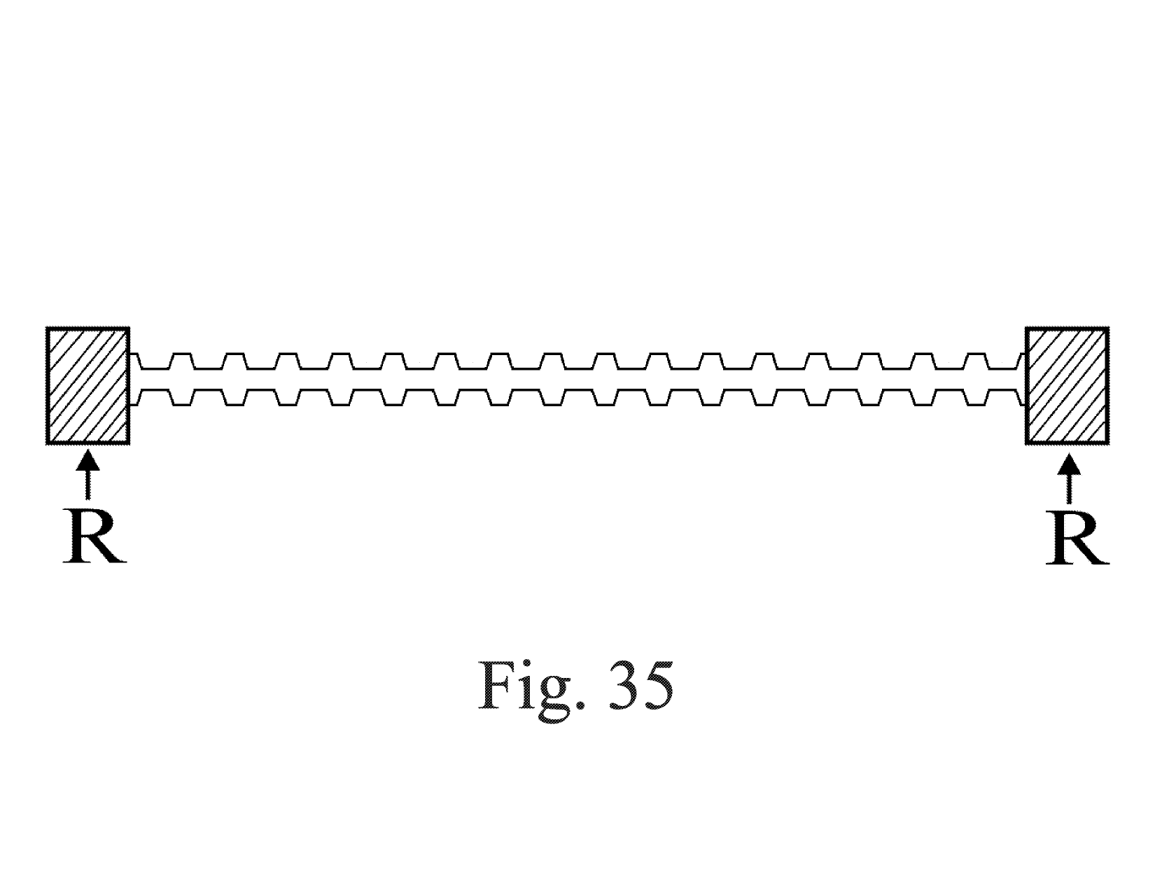

FIG. 24 to FIG. 35 disclosed some embodiments of crosstalk isolation structure of the invention.

Since the period length is much smaller than wavelength, its working frequency is far away from the band gap and the coupling with the conventional transmission line is extremely low. The present invention is applicable to high-frequency microwave circuit and high-speed circuit; in particular, the present invention can effectively block the mutual interference in an intensive circuit. In addition, the crosstalk isolation structure of the present invention can also be utilized to isolate the differential pair for preventing coupling between the differential pair and reducing the mode conversion effect from differential mode to common mode.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to be best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A crosstalk isolation structure, comprising:
a conductive line, comprising a plurality of teeth structures arranged periodically; and
two grounded resistors, connected to two ends of the conductive line, respectively, wherein
the plurality of teeth structures are periodically arranged that a period length of the plurality of teeth structures is smaller than a wavelength of an electromagnetic signal generated by a crosstalk around the conductive line.

2. The crosstalk isolation structure of claim 1, wherein the depth b of the teeth structures and the distance W₁ between a source of electromagnetic wave and the teeth structures satisfies the relation that W₁/(W₁+b)>⅓.

3. The crosstalk isolation structure of claim 1, wherein the depth b of the teeth structures and the distance W₁ between a source of electromagnetic wave and the teeth structures satisfies the relation that b/(W₁+b)<⅔.

4. The crosstalk isolation structure of claim 1, wherein the depth b of the teeth structures and the distance W1 between a source of electromagnetic wave and the teeth structures satisfies the relation that W1/(W1+b)≥ 4/9.

5. The crosstalk isolation structure of claim 1, wherein the depth b of the teeth structures and the distance W₁ between a source of electromagnetic wave and the teeth structures satisfies the relation that b/(W₁+b)≤ 5/9.

6. The crosstalk isolation structure of claim 1, wherein the depth b of the teeth structures and the distance W1 between a source of electromagnetic wave and the teeth structures satisfies the relation that W1/(W1+b)≥ 5/9.

7. The crosstalk isolation structure of claim 1, wherein the depth b of the teeth structures and the distance W₁ between a source of electromagnetic wave and the teeth structures satisfies the relation that b/(W₁+b)≤ 4/9.

8. The crosstalk isolation structure of claim 1, further comprising a substrate layer composed of at least an oxide wherein the conductive line is disposed on the substrate layer.

9. The crosstalk isolation structure of claim 1, further comprising oxide material or dielectric material between a source of electromagnetic wave and the teeth structures.

10. The crosstalk isolation structure of claim 1, wherein the grounded resistors composed of semiconductor material such as metal silicide or poly silicon or amorphous silicon or others.

11. The crosstalk isolation structure of claim 1, wherein the conductive line is made by the technology of semiconductor interconnect.

12. The crosstalk isolation structure of claim 1, wherein the period length of the plurality of teeth structures is smaller than one fourth of a wavelength of an electromagnetic signal generated by a crosstalk around the conductive line.

13. The crosstalk isolation structure of claim 1, wherein the distance W₁ between a source of electromagnetic wave and the teeth structures and a width w of a transmission line of the source of electromagnetic wave satisfies the relation that W₁/w≥ 4/7.
